(19) United States
(12) Patent Application Publication
(10) Pub. No.: US 2025/0132580 A1
(43) Pub. Date: Apr. 24, 2025

(54) Patient Support Systems For Charging Batteries Of Patient Transport Apparatuses

(71) Applicant: Stryker Corporation, Kalamazoo, MI (US)

(72) Inventors: Michael T. Brubaker, Portage, MI (US); Ross Timothy Lucas, Paw Paw, MI (US); Bradley Sommer, Lagrange, OH (US); Daniel V. Brosnan, Kalamazoo, MI (US)

(73) Assignee: Stryker Corporation, Kalamazoo, MI (US)

(21) Appl. No.: 18/570,048

(22) PCT Filed: Jun. 29, 2022
(86) PCT No.: PCT/US2022/035489

§ 371 Date: Dec. 13, 2023

Related U.S. Application Data
(60) Provisional application No. 63/254,785, filed on Oct. 12, 2021.

(51) Int. Cl. H02J 7/00; H02J 7/04

(52) U.S. Cl. CPC H02J 7/0045; H02J 7/04; H02J 2207/10; H02J 2207/20; H02J 2207/40

(57) ABSTRACT

A patient support system for charging a battery of a patient transport apparatus via power selected from first and second source types. A charger with a guide coupled to a housing supporting first and second power connectors. A charge circuit charges the battery with power received from the first or from the second source types. A selector with a bastion prevent simultaneous electrical communication of the charge circuit with power from both the first and second source types. The selector is selectively movable between: a first selector position where the bastion blocks access to the second power connector and permits access to the first power connector to charge with power from the first source type, and a second selector position where the bastion blocks access to the first power connector and permits access to the second power connector to charge with power from the second source type.

### CROSS-REFERENCE TO RELATED APPLICATIONS

The subject patent application claims priority to, and all the benefits of, U.S. Provisional Patent Application No. 63/254,785, filed on Oct. 12, 2021, the entire contents of which are incorporated by reference herein.

### BACKGROUND

Patient support systems facilitate care of patients in a health care setting. Patient support systems may include patient transport apparatuses such as, for example, hospital beds, stretchers, cots, tables, wheelchairs, and chairs. A conventional patient transport apparatus generally includes a base and an intermediate frame upon which the patient is supported via one or more deck sections such as a seat section, a fowler section, and the like. Here, a lift mechanism may be provided to facilitate adjusting the vertical height and/or configuration of the intermediate frame relative to the base. Certain types of patient transport apparatuses may also include one or more powered devices to facilitate operation of the patient transport apparatus by caregivers. By way of example, patient transport apparatuses may utilize one or more actuators, motors, and the like to facilitate operation of the lift mechanism. Similarly, some types of patient transport apparatuses may utilize motors to operate propulsion devices, such as to rotate wheels arranged for movement along floor surfaces (e.g., motorized hospital beds), or to drive tracks arranged for movement along stairs (e.g., motorized stair/evacuation chairs).

Many patient transport apparatuses which employ powered devices rely on batteries for power. Depending on the specific configuration of the patient transport apparatus, as well as the environment(s) in which the patient transport apparatus is utilized, batteries may be charged using inverters or other types of power converters integrated into the patient transport apparatus itself. Here, for example, a hospital bed may include a tether to connect to a wall outlet to charge one or more batteries stored on its base. In this illustrative example, the one or more batteries are generally not arranged for “swapping” by caregivers, and may be serviced or otherwise replaced by technicians when required. However, with other types of patient transport apparatuses, batteries may be arranged for “swapping” by caregivers as required. Here too, the patient transport apparatus itself may include a tether to facilitate charging. Moreover, the “swappable” battery may be removed from the patient transport apparatus and subsequently connected to an external charging system, realized such as by a dedicated charging station located in a healthcare facility where batteries are connected to inverters or other types of power converters and/or charge controllers.

Those having ordinary skill in the art will appreciate that certain types of patient transport apparatuses may regularly move between different healthcare facilities or locations. For example, patient transport apparatuses such as cots, wheelchairs, stair/evacuation chairs, and the like may be transported on or in ambulances or other vehicles which travel between locations and may be dispatched from dedicated locations (e.g., an ambulance bay). Because batteries for these types of patient transport apparatuses may be “swapped” while the vehicle is away from its dedicated location, chargers and extra batteries are sometimes provided on the vehicle as well as at charging stations at the dedicated location.

It will be appreciated that conventional chargers tend to be based on alternating current power from wall outlets and convert/regulate the power to charge batteries which, in turn, provide direct current power to the patient transport apparatus. While this type of arrangement works well with charging stations at the dedicated location, it can be more problematic when the charger is mounted to the vehicle. For example, many types of conventional vehicles utilized in patient care and transport employ direct current batteries that are charged by an internal combustion engine while the vehicle is in use, and are also typically charged by their own chargers/inverters when the vehicle is not in use (e.g., tethered to a wall outlet in the dedicated location). Thus, when chargers are utilized on vehicles such as ambulances, they are generally plugged into inverters on the vehicle to convert direct current power into alternating current power which, in turn, is subsequently regulated or otherwise converted yet again by the charger, often back into direct current power to charge the battery. This type of arrangement is inefficient and may require an unnecessarily large or high-capacity inverter to be installed on the vehicle in order to operate both the charger(s) and other alternating current powered devices utilized on or otherwise transported with the vehicle. Moreover, chargers for batteries of patient transport apparatuses tend to be based on either direct current or alternating current. While certain types of chargers may be configured for use with both direct current and alternating current, they tend to employ complex electronic components in order facilitate dual power type capability, and may be prohibitively expensive to manufacture.

Accordingly, there remains a need in the art to overcome one or more of the challenges described above.

### SUMMARY

The present disclosure provides a patient support system with a patient transport apparatus including: a base arranged for movement about floor surfaces, an intermediate frame with a patient support deck for supporting a patient, a lift mechanism having an actuator to move the intermediate frame relative to the base, an apparatus connector, and an apparatus controller disposed in electrical communication with the actuator and the apparatus connector; a battery having a battery connector; and a charger to charge the battery via power selected from a first source type and second source type, the charger including: a housing; a guide operatively attached to the housing, a first power connector operatively attached to the housing for receiving power from the first source type, a second power connector operatively attached to the housing and disposed in spaced relation from the first power connector for receiving power from the second source type, a charger connector for electrically coupling to the battery connector of the battery, a charge circuit disposed in electrical communication with the charger connector, the first power connector, and the second power connector to charge the battery across the charger connector coupled to the battery connector with power received from the first source type or from the second source type, and a selector having an interface movably supported by the guide, and a bastion to prevent simultaneous electrical communication of the charge circuit with power from both the first source type and the second source type, the selector being selectively movable between: a first selector position where the bastion blocks access to the second power connector and permits access to the first power connector to facilitate electrical communication of the charge circuit with power from the first source type, and a second selector position where the bastion blocks access to the first power connector and permits access to the second power connector to facilitate electrical communication of the charge circuit with power from the second source type.

The present disclosure also provides a charger for use in charging a battery of a patient transport apparatus via power selected from a first source type and second source type, the charger including: a housing; a guide operatively attached to the housing; a first power connector operatively attached to the housing for receiving power from the first source type; a second power connector operatively attached to the housing and disposed in spaced relation from the first power connector for receiving power from the second source type; a charger connector for electrically coupling to the battery; a charge circuit disposed in electrical communication with the charger connector, the first power connector, and the second power connector to charge the battery across the charger connector with power received from the first source type or from the second source type; and a selector having an interface movably supported by the guide, and a bastion to prevent simultaneous electrical communication of the charge circuit with power from both the first source type and the second source type, the selector being selectively movable between: a first selector position where the bastion blocks access to the second power connector and permits access to the first power connector to facilitate electrical communication of the charge circuit with power from the first source type, and a second selector position where the bastion blocks access to the first power connector and permits access to the second power connector to facilitate electrical communication of the charge circuit with power from the second source type.

### BRIEF DESCRIPTION OF THE DRAWINGS

Advantages of the present disclosure will be readily appreciated as the same becomes better understood by reference to the following detailed description when considered in connection with the accompanying drawings, wherein:

FIG. 1 is a left-side plan view of a patient support system according to the present disclosure, shown with a patient transport apparatus positioned adjacent to a battery and to chargers for charging the battery.

FIG. 2 is a schematic view of portions of the patient support system of FIG. 1, shown with the charger arranged for electrical communication with first and second source types of power for charging the battery.

FIG. 3 is a partially exploded perspective view of portions of the patient support system of FIGS. 1-2, shown with the battery spaced from the charger and with the charger disposed in electrical communication with the first source type via a power cable.

FIG. 4A is a back-side plan view of the charger and the battery of FIG. 3, shown with the charger having a selector arranged in a first selector position to permit access to a first power connector.

FIG. 4B is another back-side plan view of the charger and the battery of FIG. 4A, shown with the selector arranged in a second selector position to permit access to a second power connector.

FIG. 5A is a partially-exploded perspective view of the charger and the battery of FIG. 4A, shown with a first power cable spaced from the first power connector.

FIG. 5B is a partially-exploded perspective view of the charger and the battery of FIG. 4B, shown with a second power cable spaced from the second power connector.

FIG. 6 is a partially-exploded perspective view of portions of the charger of FIGS. 1-5B, shown with a housing spaced from a mounting assembly and from an environmental surface.

FIG. 7 is a partially-exploded perspective view of portions of the charger of FIG. 6, shown with the mounting assembly spaced from the housing.

FIG. 8A is a perspective view of the portions of the charger of FIG. 6, shown with the mounting assembly coupled to the housing and with the selector arranged in the first selector position.

FIG. 8B is another perspective view of the portions of the charger of FIG. 8A, shown with the selector arranged in the second selector position.

FIG. 9 is a partial, broken-out section view taken along line 9-9 of FIG. 4B.

FIG. 10 is a partially-exploded perspective view of portions of the charger of FIGS. 1-9.

FIG. 11 is another partially-exploded perspective view of the portions of the charger of FIG. 10.

FIG. 12 is a perspective view depicting portions of the charger of FIGS. 1-11 shown prior to attachment of the selector or the mounting assembly.

FIG. 13 is a perspective view of the selector of the charger of FIGS. 1-11.

FIG. 14 is another perspective view of the selector of FIG. 13.

FIG. 15A is a perspective view depicting portions of the charger of FIGS. 1-11, shown with the selector arranged for attachment to a guide coupled to the housing.

FIG. 15B is another perspective view of the portions of the charger of FIG. 15A, shown with the selector moved into initial engagement with the guide.

FIG. 15C is another perspective view of the portions of the charger of FIG. 15B, shown with the selector secured to the guide.

FIG. 16 is a partial perspective view depicting portions of the guide of the charger of FIGS. 1-11 and 15A-15C.

FIG. 17 is a partial perspective view depicting portions of the guide of the charger of FIGS. 1-11 and 15A-16, shown with the selector secured to the guide.

FIG. 18A is a perspective view of the charger of FIGS. 1-11 and 15A-17, shown with the housing supporting a release mechanism having a latch depicted in a retain position.

FIG. 18B is another perspective view of the charger of FIG. 18A, shown with latch of the release mechanism arranged in a release position.

FIG. 19A is another perspective view of the charger of FIG. 18A, shown with portions of the charger depicted in phantom outline to illustrate the arrangement of the release mechanism.

FIG. 19B is another perspective view of the charger of FIG. 18B, shown with portions of the charger depicted in phantom outline to illustrate the arrangement of the release mechanism.

### DETAILED DESCRIPTION

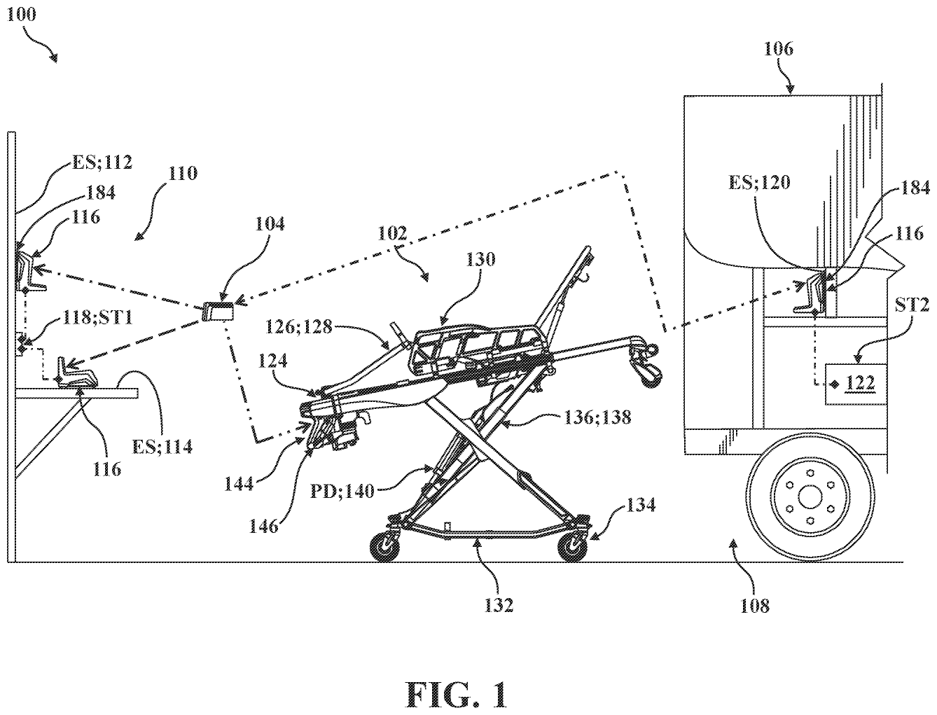

Referring now to FIG. 1, a patient support system 100 is shown with a patient transport apparatus 102 configured with one or more powered devices PD operated utilizing power stored in a battery 104. In the version illustrated in FIG. 1, the patient transport apparatus 102 is realized as a cot shown positioned adjacent to an ambulance 106 parked within a bay 108 of a healthcare facility, such as a garage from which the ambulance 106 may be dispatched along with the patient transport apparatus 102 to provide patient care and/or transport. However, it will be appreciated that other types of patient transport apparatuses 102 are contemplated by the present disclosure, including without limitation beds, wheelchairs, stair/evacuation chairs, stretchers, or any other type of patient transport/support apparatus which employs powered devices PD.

In the illustrative example depicted in FIG. 1, the bay 108 in which the ambulance 106 is parked is also situated adjacent to a charging station 110 with a room wall 112 and a table 114. Here, chargers 116 of the patient support system 100 according to the present disclosure are mounted or otherwise positioned, and are arranged for electrical communication with a first source type ST1 of power utilized to charge batteries 104. As is described in greater detail below, the first source type ST1 of power may be realized in a number of different ways, but in this illustrative example the first source type ST1 of power is realized as alternating current AC power provided such as via a wall outlet 118 connected to mains power (e.g., 110-220 volts 50-60 Hz AC power). In addition to the charging station 110, the ambulance 106 is also provided with a charger 116 mounted in a cubby 120 arranged adjacent to where the patient transport apparatus 102 may be loaded. Here, the charger 116 mounted in the cubby 120 is arranged for electrical communication with a second source type ST2 of power utilized to charge batteries 104.

The second source type ST2 of power is different from the first source type ST1, and may likewise be realized in a number of different ways, but in this illustrative example the second source type ST2 of power is realized as direct current DC power provided such as by a vehicle battery 122 (e.g., 10-14 volts DC power) charged by an alternator of an internal combustion engine and/or by an inverter tethered to another wall outlet 118 (not shown in detail, but generally known in the related art).

As will be appreciated from the subsequent description below, the patient support system 100 of the present disclosure enables the same type of charger 116 to be utilized in order to charge batteries 104 using power from either the first source type ST1 or the second source type ST2 in a cost-effective, and straightforward manner. Put differently, the charger 116 is capable of being connected to or otherwise utilizing power provided by either the first source type ST1 or the second source type ST2 to charge the battery 104. The various components introduced above will each be described in greater detail below.

The patient transport apparatus 102 depicted in FIG. 1 includes an intermediate frame 124 configured to support the patient. The intermediate frame 124 can be like that shown in U.S. Pat. No. 10,987,268, entitled “Emergency Cot With A Litter Height Adjustment Mechanism,” the disclosure of which is hereby incorporated by reference in its entirety. The intermediate frame 124 may be coupled to a variety of components that aid in supporting and/or transporting the patient. For example, in the illustrative version, the intermediate frame 124 is coupled to a patient support deck 126 defining a patient support surface 128 upon which the patient directly rests. The patient support deck 126 may be defined by one or more articulable deck sections (e.g., a fowler section, a seat section, a leg section, a head section, and the like) to facilitate care and/or transportation of the patient in various patient positions.

The intermediate frame 124 may also be coupled to hand rails 130. In FIG. 1, the hand rails 130 extend from opposing sides of the intermediate frame 124 and provide egress barriers for the patient on the patient support deck 126. The hand rails 130 may also be utilized by an individual, such as a caregiver, an emergency medical technician (EMT), or another medical professional, to move or manipulate the patient transport apparatus 102. In some versions, the hand rails 130 may include a hinge, pivot, or similar mechanism to allow the hand rails 130 to be folded or stored adjacent to or below the patient support deck 126.

The patient transport apparatus 102 may include a base 132 arranged for movement about floor surfaces, such as via caster wheel assemblies 134 operatively connected adjacent to each corner of the base 132. The caster wheel assemblies 134 may be configured to swivel in order to facilitate turning of the patient transport apparatus 102. The caster wheel assemblies 134 may include a swivel locking mechanism to prevent the caster wheel assemblies 134 from swiveling when engaged (not shown in detail). The caster wheel assemblies 134 may also include wheel brakes to prevent rotation of the wheels (not shown in detail).

The patient transport apparatus 102 illustrated in FIG. 1 includes a lift mechanism 136 interposed between the base 132 and the intermediate frame 124. The lift mechanism 136 is configured to move between a plurality of vertical configurations, including an extended configuration where the intermediate frame 124 is elevated relative to the base 132 (see FIG. 1), and a retracted configuration (not shown) where the intermediate frame 124 is lowered so as to be in closer proximity to the base 132. The lift mechanism 136 can be like that shown in the U.S. Pat. No. 10,987,268. Other configurations are contemplated.

While moving between the plurality of vertical configurations, the lift mechanism 136 may move either the base 132 or the intermediate frame 124 relative to the other of the intermediate frame 124 or the base 132 depending on how the patient transport apparatus 102 is supported during use. For example, the patient transport apparatus 102 may be supported at the intermediate frame 124 when the patient transport apparatus 102 is being unloaded/loaded into the ambulance 106, and the patient transport apparatus 102 may be supported at the base 132 when the patient transport apparatus 102 is resting on a floor or ground surface (e.g., as depicted in FIG. 1). In instances where the patient transport apparatus 102 is supported by the intermediate frame 124, the lift mechanism 136, while moving between the plurality of vertical configurations, moves the base 132 relative to the intermediate frame 124. In instances where the patient transport apparatus 102 is supported at the base 132, the lift mechanism 136, while moving between the plurality of vertical configurations, moves the intermediate frame 124 relative to the base 132.

The patient transport apparatus 102 may include a variety of components that allow the lift mechanism 136 to move between the plurality of vertical configurations. For example, in the version of FIG. 1, the lift mechanism 136 is provided with telescoping X-frames 138 that interconnect the base 132 and the intermediate frame 124. While not illustrated in detail herein, portions of the X-frames 138 are pivotably coupled to the base 132, and are slidingly and pivotably coupled to the intermediate frame 124. However, other configurations are contemplated.

Those having ordinary skill in the art will appreciate that the lift mechanism 136 may move between the plurality of vertical configurations due to a caregiver applying a manual action to the lift mechanism 136, or components thereof. However, in the illustrated version, the lift mechanism is realized as a powered device PD driven using the battery 104. To this end, the lift mechanism 136 includes one or more actuators 140, which may be coupled to any suitable component of the lift mechanism 136 and may be configured to move the lift mechanism 136 between the plurality of vertical configurations. In the illustrated version, the actuator 140 is realized as a hydraulic linear actuator that is driven by a motorized pump (not shown in detail) using power from the battery 104. Similar actuators 140 are described in U.S. Pat. No. 7,398,571, entitled “Ambulance Cot and Hydraulic Elevating Mechanism Therefor,” the disclosure of which is hereby incorporated by reference in its entirety. Furthermore, techniques for utilizing actuators 140 to manipulate components of the patient transport apparatus 102 can be like those described in U.S. Pat. No. 10,987,268. Other configurations are contemplated.

In some versions, the actuator 140 may not be the hydraulic linear actuator shown in FIG. 1. The actuator 140 may be any actuator suitable for actuating the lift mechanism 136 such that the lift mechanism 136 moves between the plurality of vertical configurations. For example, the actuator 140 may be an electric motor, a servo motor, a pneumatic actuator, or any other suitable actuator.

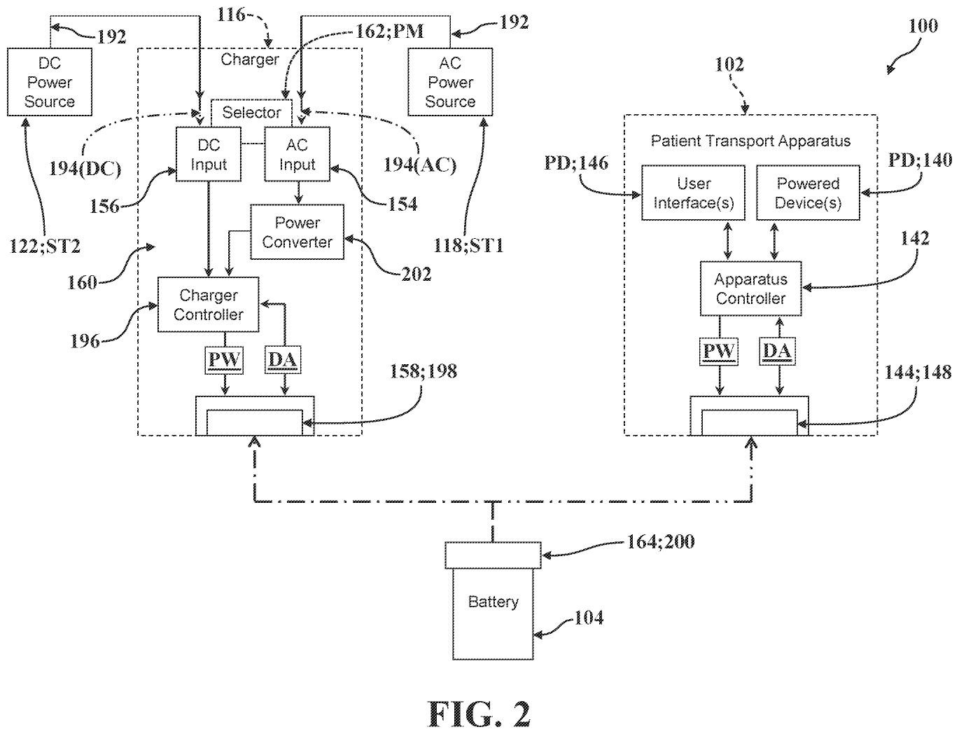

Referring now to FIG. 2, in order to facilitate operation of the actuator 140 to move the lift mechanism 136, the patient transport apparatus 102 generally includes an apparatus controller 142 disposed in electrical communication with an apparatus connector 144, one or more powered devices PD (e.g., the motorized pump for the actuator 140), and one or more user interfaces 146. The apparatus connector 144 (not shown in detail) is generally configured to electrically couple with the battery 104 when secured to the patient transport apparatus 102, and generally includes a plurality of apparatus connector terminals 148 across which power PW from the battery 104 is transmitted (e.g., power and ground connections). In some versions, one or more apparatus connector terminals 148 may be utilized to exchange data DA with the battery 104, such as charging information and/or state, sensor data (e.g., temperature, humidity, moisture, and the like) from sensors on the battery 104 and/or the patient transport apparatus 102 (not shown), authentication data, and the like. Other configurations are contemplated.

The apparatus controller 142 is provided to control operation of the one or more powered devices PD which form a part of or otherwise cooperate with the patient transport apparatus 102. To this end, the apparatus controller 142 may employ one or more microprocessors for processing instructions or an algorithm stored in memory to control operation of the one or more powered devices PD. Additionally or alternatively, the apparatus controller 142 may comprise one or more microcontrollers, field programmable gate arrays, systems on a chip, discrete circuitry, and/or other suitable hardware, software, and/or firmware that is capable of carrying out the functions described herein. The apparatus controller 142 may comprise one or more subcontrollers configured to control the one or more powered devices PD, and/or one or more subcontrollers for each of the one or more powered devices PD.

The user interface 146 is generally provided to facilitate operation of the powered devices PD, and is disposed in electrical communication with the apparatus controller 142. Here, a single user interface 146, or more than one user interface 146, may be provided to facilitate operating one or more powered devices PD using power from the battery 104. While not illustrated in detail herein, it will be appreciated that user interfaces 146 may be configured to be actuated in a variety of different ways, including but not limited to, mechanical actuation (hand, foot, finger, etc.), hands-free actuation (voice, foot, etc.), and the like. User interfaces 146 may comprise one or more of a load cell, a push button, a touch screen, a joystick, a twistable control handle, a dial, a knob, a gesture sensing device for monitoring motion of hands, feet, face, or other body parts of the user (such as through a camera), a microphone for receiving voice activation commands, a foot pedal, and a sensor (e.g., infrared sensor such as a light bar or light beam to sense a user's body part, ultrasonic sensor, etc.). Additionally, buttons/pedals may be physical buttons/pedals, or may be virtually-implemented buttons/pedals such as through optical projection or forming part of a graphical user interface presented on a touchscreen. Buttons/pedals may also be mechanically-implemented in some versions, or may drive-by-wire type buttons/pedals where a user-applied force actuates a sensor such as a switch or potentiometer. Other configurations are contemplated.

As noted above, while the representative version of the patient transport apparatus 102 described herein employs a powered device PD realized as an electric motor used to drive a hydraulic pump to operate the actuator 140, other types of powered devices PD are contemplated by the present disclosure. By way of non-limiting example, powered devices PD may include lighting or illumination devices, alert or alarm systems, sensor systems, communication systems, patient treatment systems, patient monitoring systems, medical devices and/or tools, and other types of powered devices PD utilized in the transport or care of patients in connection with patient transport apparatuses 102. Furthermore, while the representative patient transport apparatus 102 illustrated in FIG. 1 is realized as a cot, other types, styles, and/or configurations of patient transport apparatus 102 are contemplated. By way of non-limiting example, the patient transport apparatus 102 may be realized as a stair/evacuation chair which employs one or more powered devices PD, such as motorized track driving devices employed to move along stairs (not shown). Similar track driving devices and/or powered devices PD utilized in connection with patient transport apparatuses 102 are described in U.S. Pat. No. 9,486,373, entitled “Reconfigurable Patient Support;” U.S. Pat. No. 9,510,981, entitled “Reconfigurable Transport Apparatus;” U.S. Pat. No. 10,758,437, entitled “Patient Transfer Apparatus With Integrated Tracks;” and/or U.S. Pat. No. 10,857,047, entitled “Variable Speed Patient Transfer Apparatus,” the disclosures of each of which are hereby incorporated by reference in their entirety. Other configurations are contemplated.

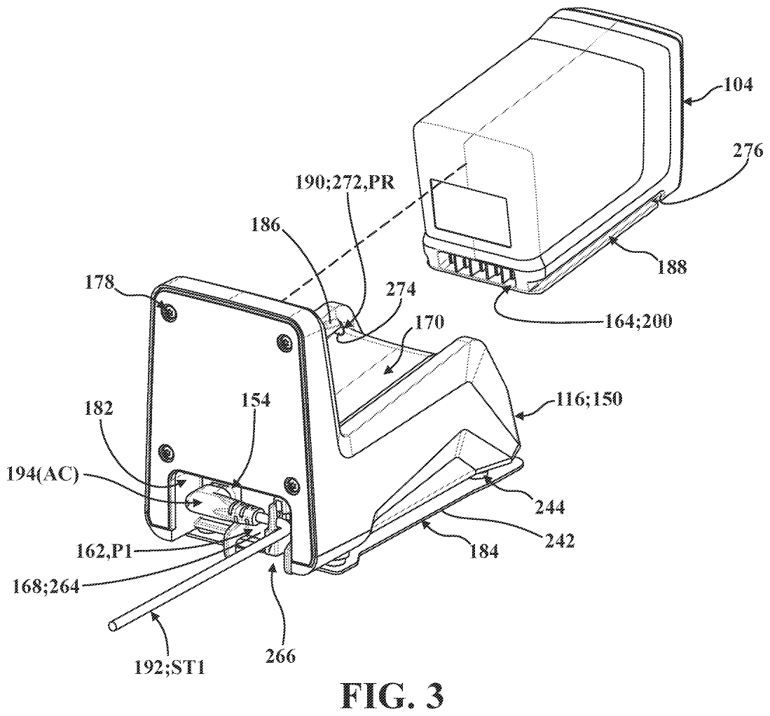

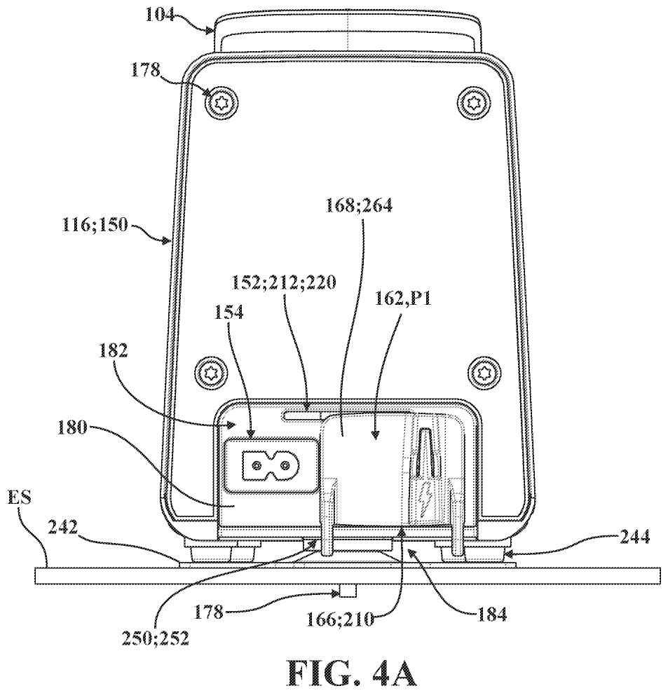

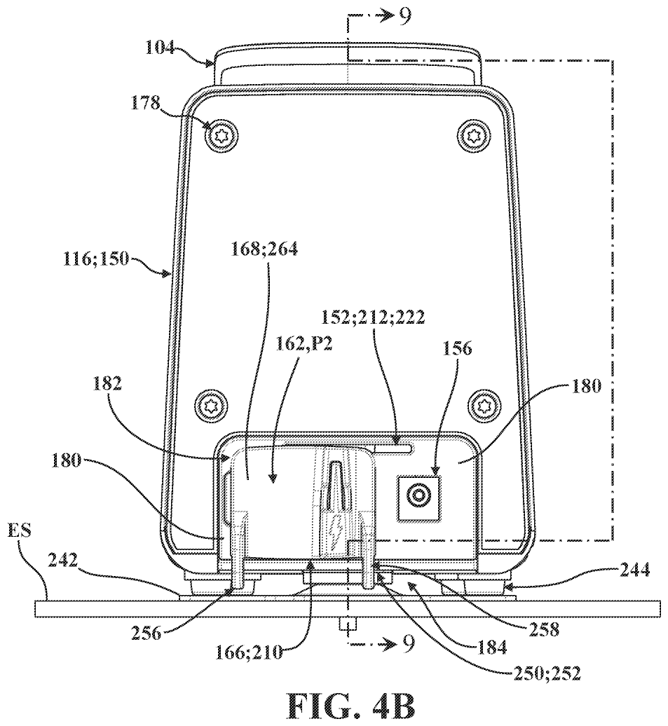

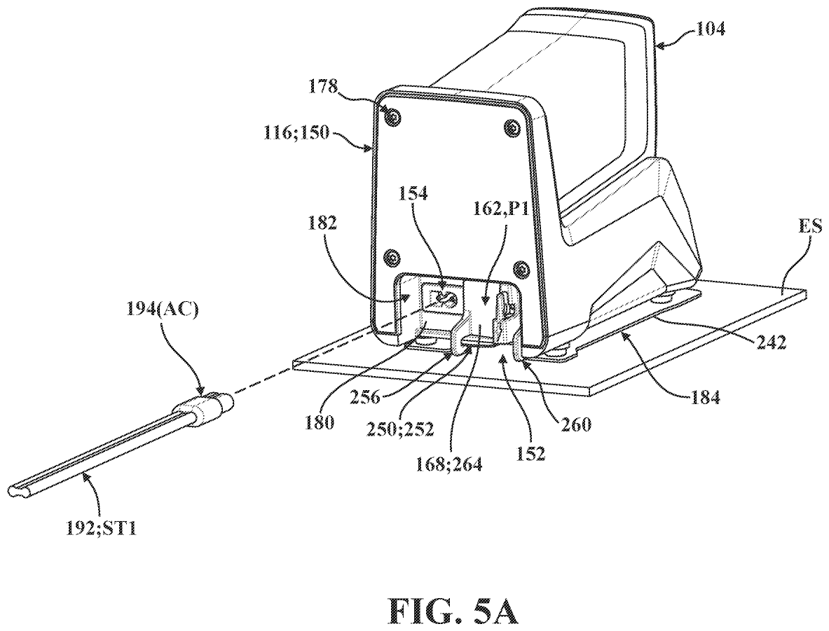

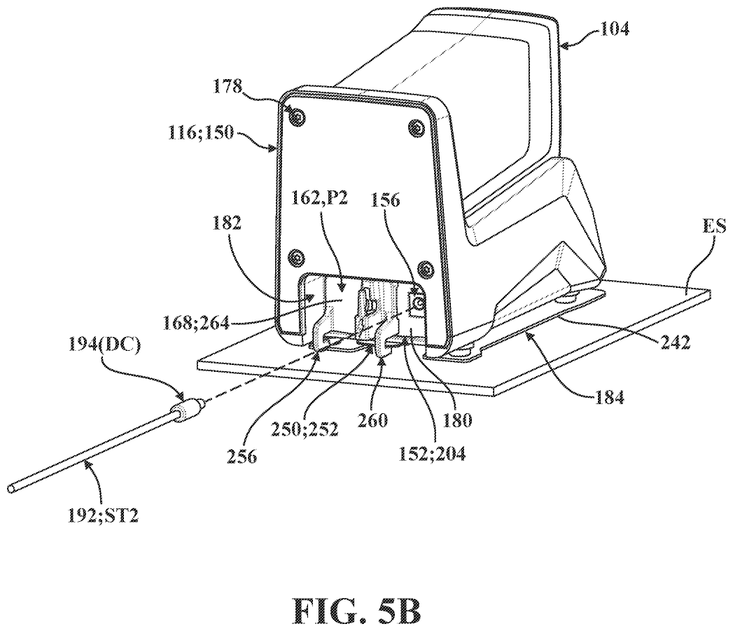

Referring now to FIGS. 2-5B, as noted above, the patient support system 100 of the present disclosure includes a charger 116 for use in charging the battery 104 of the patient transport apparatus 102 via power selected from a first source type ST1 (e.g., alternating current AC power) and a second source type ST2 (e.g., direct current DC power). To this end, the charger 116 generally includes a housing 150, a guide 152, a first power connector 154, a second power connector 155, a charger connector 158, a charge circuit 160, and a selector 162. The guide 152 is operatively attached to the housing 150 and, as described in greater detail below, supports the selector 162 for movement between a first selector position P1 (see FIGS. 3-4A and 5A) and a second selector position P2 (see FIGS. 4B and 5B). The first power connector 154 is operatively attached to the housing 150 and is configured for receiving power from the first source type ST1. The second power connector 156 is similarly operatively attached to the housing 150, but is configured for receiving power from the second source type ST2.

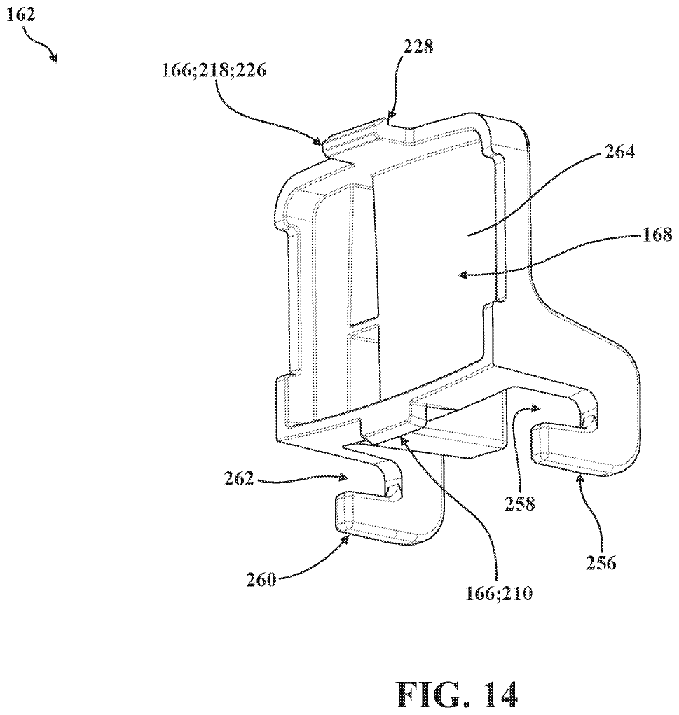

The charger connector 158 is provided for electrically coupling to a battery connector 164 of the battery 104 and is disposed in electrical communication with the charge circuit 160. The charge circuit 160 is also disposed in electrical communication with the first power connector 154 and the second power connector 156, and is configured to facilitate charging the battery 104 across the charger connector 158 with power received from the first source type ST1 or from the second source type ST2. The selector 162 has an interface 166 movably supported by the guide 152 (see FIGS. 14 and 16-17), and a bastion 168 to prevent simultaneous electrical communication of the charge circuit 160 with power from both the first source type ST1 and the second source type ST2.

When the selector 162 is in the first selector position P1, the bastion 168 blocks access to the second power connector 156 and permits access to the first power connector 154 to facilitate electrical communication of the charge circuit 160 with power from the first source type ST1 (see FIGS. 3-4A and 5A). When the selector 162 is in the second selector position P2, the bastion 168 blocks access to the first power connector 154 and permits access to the second power connector 156 to facilitate electrical communication of the charge circuit 160 with power from the second source type ST2 (see FIGS. 4B and 5B). Each of the portions of the charger 116 introduced above will be described in greater detail below.

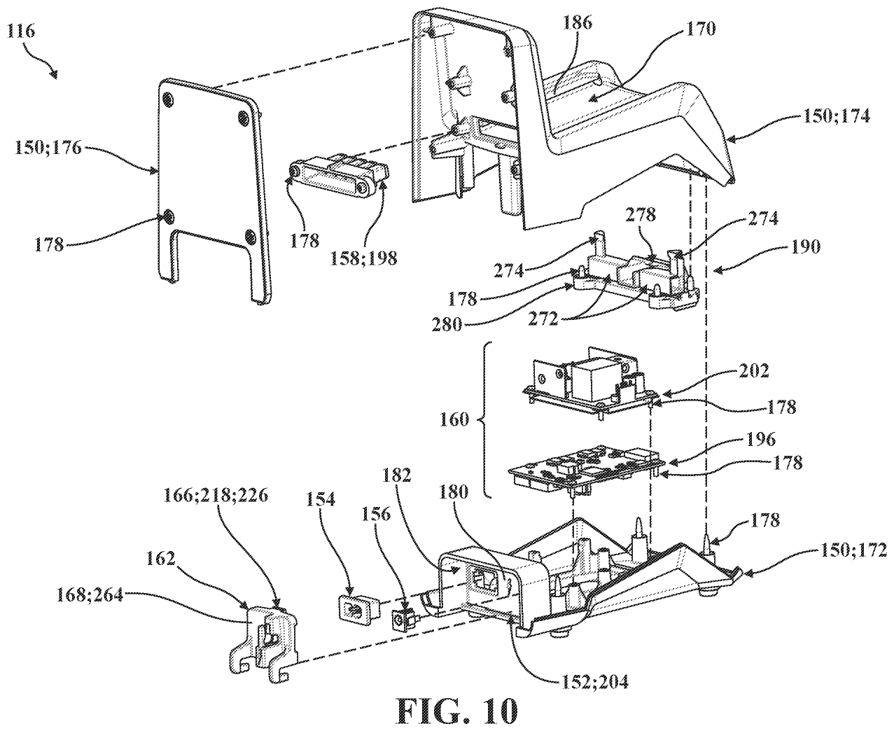

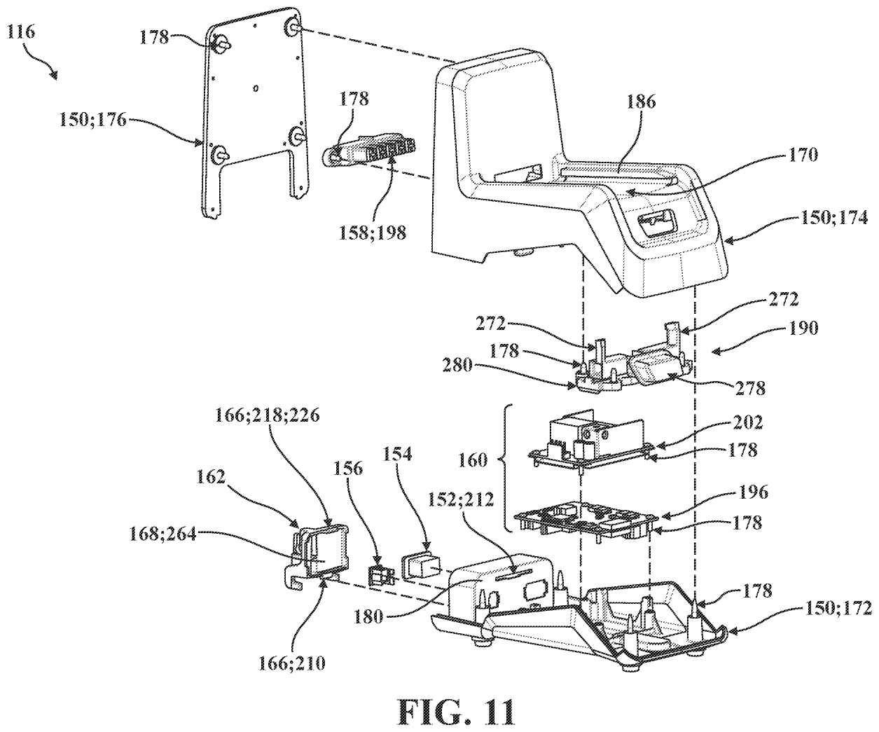

As noted above, the charger 116 employs the housing 150 to, among other things, support the first and second power connectors 154, 156, the charger connector 158, and other components, and also acts to support the battery 104 during charging. In the illustrated versions, the housing 150 includes a base body 172 as well as a cover 174 and a plate 176 which are operatively attached to the base body 172 via one or more fasteners 178 (e.g., screws, bolts, and the like; see FIGS. 10-11). However, it will be appreciated that the housing 150 could be realized or otherwise defined by any suitable number of components attached together in various ways without departing from the scope of the present disclosure. By way of non-limiting example, the housing 150 could be realized by or formed as a single, unitary component in some versions. Other configurations are contemplated.

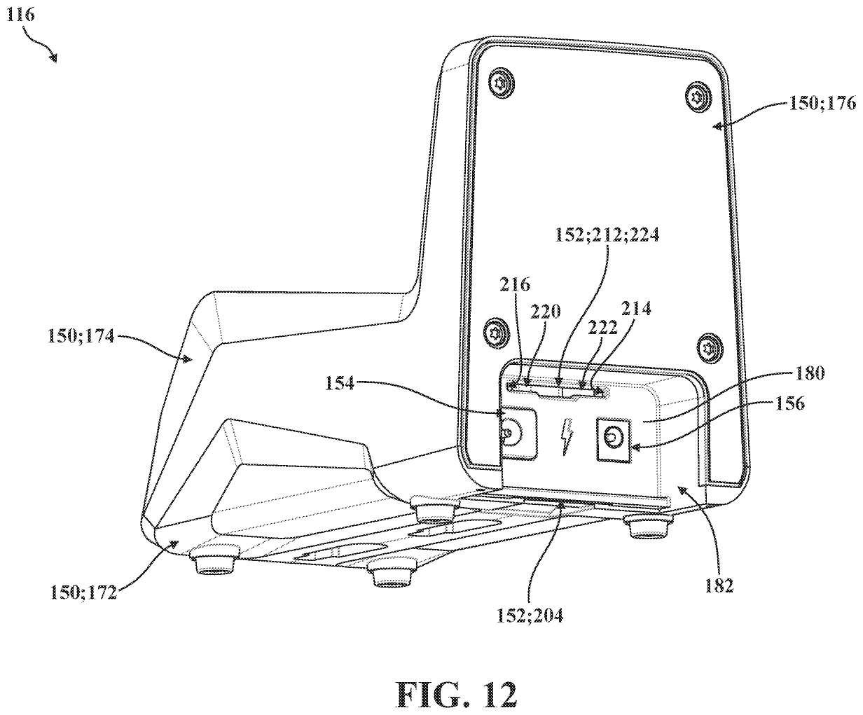

The base body 172 of the housing 150 supports, among other things, the first and second power connectors 154, 156, as well as components of the charge circuit 160, as described in greater detail below. The base body 172 also defines the guide 152 in the illustrated version, as described in greater detail below, but it will be appreciated that the guide 152 could be operatively attached to the housing 150 in other ways, formed integrally with one or more parts of the housing 150 and/or by other components that are operatively attached to the housing 150. In the illustrated version, the guide 152 is arranged adjacent to a wall 180 supporting the first and second power connectors 154, 156. Here, the wall 180 is spaced from and generally parallel to the plate 176, and defines a portion of a pocket 182 which accommodates the selector 162. The guide 152 is described in greater detail below in connection with FIGS. 12-17.

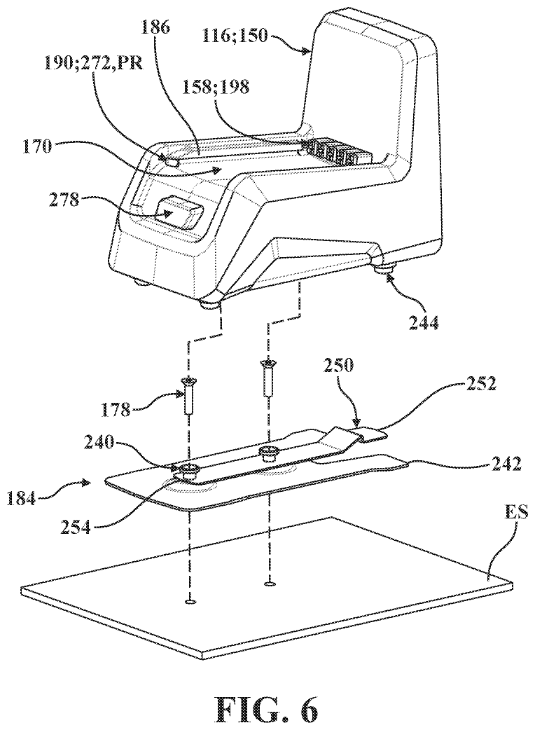

The base body 172 is also configured to removably secure or otherwise operatively attach to a mounting assembly 184 employed to facilitate securing the charger 116 to an environmental surface ES, such as a portion of the room wall 112 or the cubby 120 depicted in FIG. 1, as is described in greater detail below in connection with FIGS. 6-9.

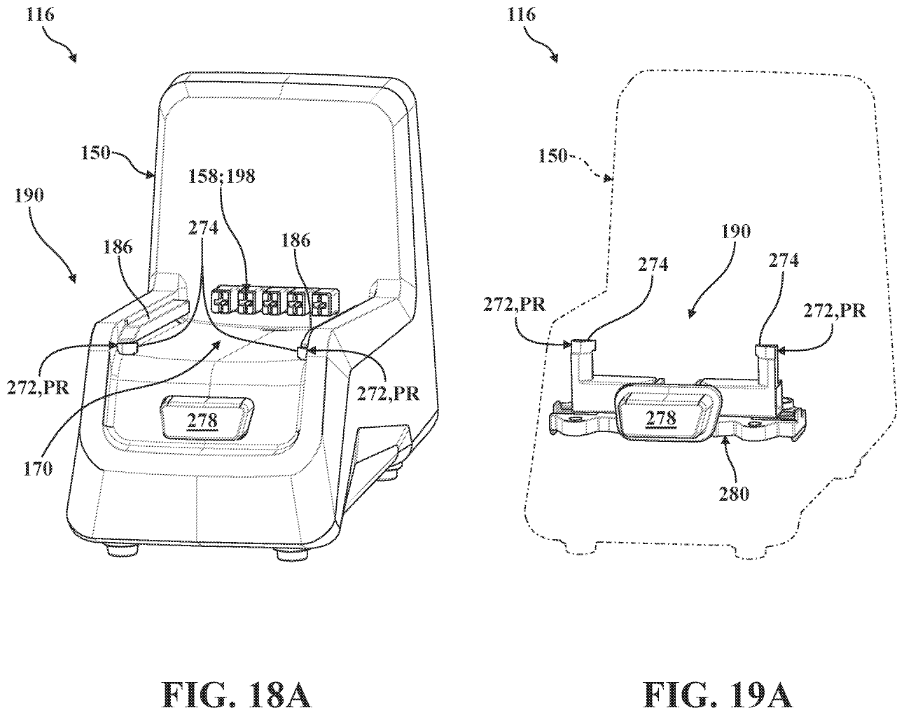

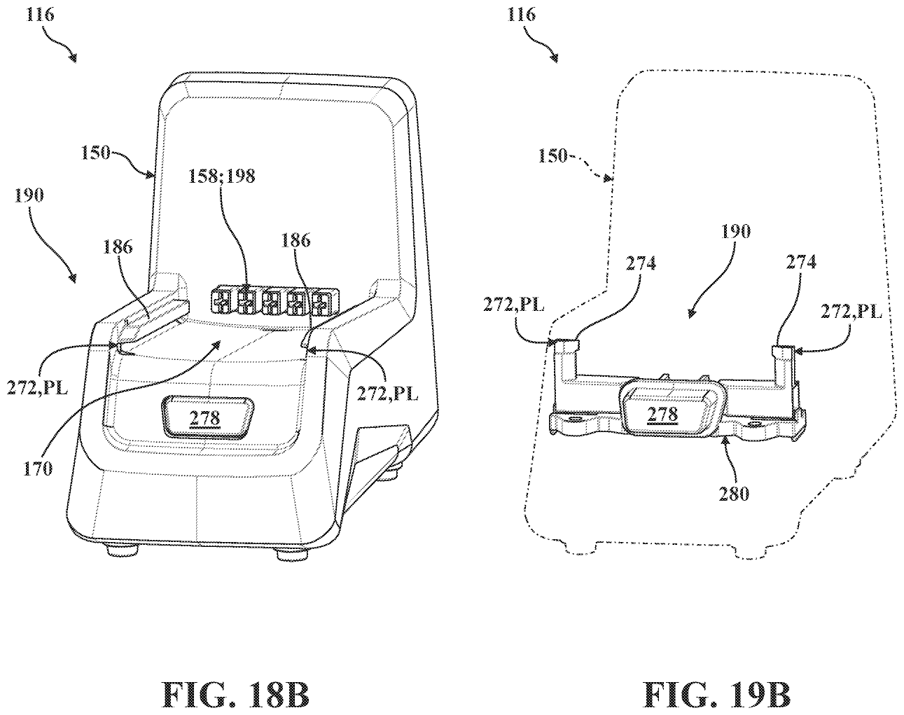

The cover 174 of the housing 150 supports the charger connector 158 and defines the battery track 170, which is formed as a pair of charger rails 186 shaped to engage corresponding battery slots 188 formed in the battery 104. Here, sliding engagement between the charger rails 186 and the battery slots 188 helps facilitate guiding the battery connector 164 into and out of electrical coupling with the charger connector 158 to charge the battery 104. In the illustrated version, the cover 174 of the housing 150 also supports a retention mechanism 190 configured to releasably secure the battery 104 to the charger 116 as described in greater detail below in connection with FIGS. 18A-19B.

With continued reference to FIGS. 2-5B, as noted above, the charger 116 is able to be connected to or otherwise utilize power provided by either the first source type ST1 or the second source type ST2 to charge the battery 104, with movement of the selector 162 blocking one of the first and second power connectors 154, 156 while permitting access to the other of the first and second power connectors 154, 156. Here, the first and second power connectors 154, 156 are of different configurations to facilitate releasably electrically coupling to power cables 192 of different types and having different power cable connectors 194. More specifically, FIGS. 3 and 5A depict a power cable 192 with an alternating current AC power cable connector 194AC configured for attachment to the first power connector 154, and FIG. 6 depicts a power cable 192 with a direct current DC power cable connector 194DC configured for attachment to the second power connector 156. The first power connector 154 is configured to releasably receive the alternating current AC power cable connector 194AC when the selector 162 is disposed in the first selector position ST1, and the second power connector 156 is configured to releasably receive the direct current DC power cable connector 194DC when the selector 162 is disposed in the second selector position ST2. It will be appreciated that the first and second power connectors 154, 156, as well as the alternating current AC power cable connector 194AC and/or the direct current DC power cable connector 194DC, could be configured in a number of different ways sufficient to facilitate electrical communication of the first and second source types ST1, ST2 with the charge circuit 160 via the respective power cables 192.

Referring now to FIG. 2, the illustrated version of the charge circuit 160 generally includes a charger controller 196 disposed in electrical communication with the charger connector 158, the first power connector 154, and the second power connector 156. The charger controller 196 is configured to regulate power transfer to the battery 104 across the charger connector 158. To this end, the charger connector 158 includes a plurality of charger connector terminals 198 across which power from the battery 104 is transmitted (e.g., power and ground connections). Here, the battery connector 164 of the battery 104 similarly includes a plurality of battery connector terminals 200 arranged to releasably couple in electrical communication to corresponding charger connector terminals 198, as well as to the apparatus connector terminals 148 described above. In some versions, one or more charger connector terminals 198 and/or battery connector terminals 200 may similarly be utilized to exchange data DA between the battery 104 and the charger 116, such as charging information and/or state, sensor data (e.g., temperature, humidity, moisture, and the like) from sensors on the battery 104 and/or the charger 116 (not shown), authentication data, and the like. Other configurations are contemplated.

The charger controller 196 is generally configured to direct power to the battery 104 in order to charge the battery 104. It will be appreciated that, like the apparatus controller 142 described above, the charger controller 196 may include, employ, or otherwise be defined by a number of different components which cooperate to facilitate charging the battery 104. To this end, the charger controller 196 may utilize one or more components such as integrated circuits, resistors, capacitors, inductors, voltage regulators, processors, memory devices, and the like to provide power PW to charge the battery 104. In some versions, the charger controller 196 may communicate with one or more user interfaces of the patient support system 100 to receive inputs from the user (e.g., the caregiver) and/or to provide outputs to the user (not shown in detail). By way of non-limiting example, the patient transport apparatus 102, the battery 104, and/or the charger 116 may include user interfaces configured to present the user with information about the charge state, identity, condition, status, or other parameters of the battery 104, such as via one or more light emitting diodes LEDs, graphical user interfaces GUIs presented on display screens, and the like. Other configurations are contemplated.

Depending on the specific configuration of the battery 104, the charger controller 196 may be configured to balance or otherwise optimize charging of cells of the battery 104 (not shown) according to various charging profiles, strategies, and the like. While not illustrated in detail herein, those having ordinary skill in the art will appreciate that the battery 104 may include a single cell, or a plurality of cells electrically coupled to one another in order to increase storage capacity, voltage, or other parameters of the battery 104. The battery 104 may utilize cells having a variety of compositions. For example, the cells may be Lithium-ion type, however other types of batteries 104 are contemplated such as Lead-Acid type batteries 104. Nickel-Cadmium, Nickel-metal hydride, or Lithium polymer are also contemplated. In some versions, the battery 104 may be configured to provide one or more target voltages across certain battery connector terminals 200 terminal by way of the arrangements of the cells (e.g. series, parallel, series-parallel, and the like). For example, the battery 104 may provide direct current DC power at 3.7V, 5V, 6V, 12V, 18V, 36V, 40V, 60V, or other suitable voltages, as well as combinations thereof (e.g., 12V and also 5V). Other configurations are contemplated.

In some versions, such as where the battery 104 is configured to provide approximately 12V-24V to the patient transport apparatus 102, the charger controller 196 may be configured to output power PW at similar voltages and with sufficient current to charge the battery 104. Here, it will be appreciated that the specific voltage and/or current of the power PW transferred to the battery 104 may be predetermined (e.g., “fixed”), or may be variable in order to, among other things, charge the battery 104 over a specific time period, maintain a target temperature of the battery 104, optimize expected life of the battery 104, and the like. Other configurations are contemplated. In some versions, the charger controller 196 may adjust the voltage supplied by the second source type ST2 (and/or the first source type ST1) before power is transferred to the battery 104. By way of non-limiting example, if second source type ST2 provides direct current DC power at approximately 13.5V (e.g., as generated by the ambulance 106 engine alternator), the charger controller 196 or another portion of the charge circuit 160 may filter and/or adjust the power directed to the battery 104 to approximately 12V. In some versions, the charger controller 196 and/or other portions of the charge circuit 160 may be configured to “step up” and/or “step down” voltage, current, and the like. While aspects of the forgoing are described in greater detail below in connection with versions of the patient support system 100 where the first source type ST1 is based on alternating current AC power, it is contemplated that the first and second source types ST1, ST2 could instead both be configured to provide direct current (or alternating current) power at different voltages and/or current levels, or to otherwise provide different types of power to the charge circuit 160. Other configurations are contemplated.

In some versions, the charge circuit 160 also includes a power converter 202 interposed in electrical communication between the first power connector 154 and the charger controller 196 to adjust one or more parameters of the power received from the first source type ST1 and to transfer adjusted power to the charger controller 196. By way of non-limiting example, the power converter 202 may be configured to adjust a current and/or a voltage of the power received from the first source type ST1. More specifically, in some versions, the power converter 202 may be configured to adjust alternating current AC power received from the first source type ST1 into direct current DC power supplied to the charger controller 196. Here, for example, the power converter 202 could be configured to adjust alternating current AC power provided by the first source type ST1 at approximately 110-220V 50-60 Hz into direct current DC power at approximately 12V. In some versions, the power converter 202 may be configured to adjust the power provided by the first source type ST1 into direct current power at voltages which are substantially to the voltages of the power provided by the second source type ST2. Other configurations are contemplated.

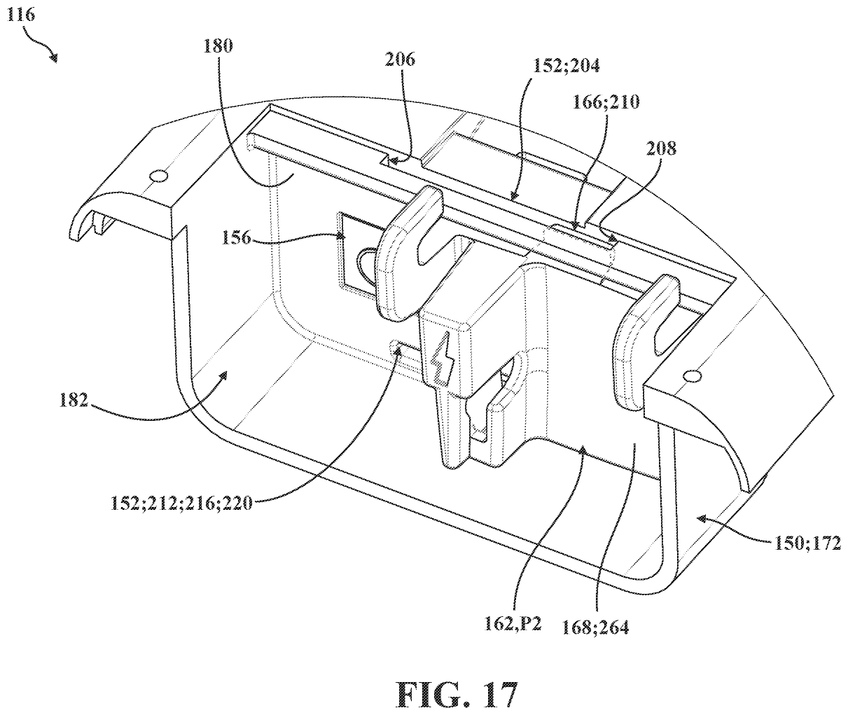

Referring now to FIGS. 12-17, as noted above, the guide 152 is operatively attached to the housing 150 and supports the selector 162 for movement between the first and second selector positions P1, P2, and is formed integrally with the base body 172 of the housing 150 adjacent to the pocket 182 and the wall 180. However, it will be appreciated that all or a portion of the guide 152 could be defined by separate components that operatively attach to the housing 150. In the illustrated version, the guide 152 includes a slot 204 extending between a first slot end 206 and a second slot end 208 (see FIG. 17), and the interface 166 of the selector 162 includes a tab 210 shaped for removable engagement with the slot 204 (see FIGS. 14 and 17). The tab 210 is arranged to abut the first slot end 206 when the selector 162 is disposed in the first selector position P1, and to abut the second slot end 208 when the selector 162 is disposed in the second selector position P2. Here, the abutting engagement between the tab 210 and the first and second slot ends 206, 208 of the slot 204 limits movement of the selector 162 relative to the housing 150 between the first and second selector positions P1, P2 within the pocket 182.

In the illustrated version, the guide 152 also includes a track 212 disposed in spaced relation from the slot 204 and extending between a first track end 214 and a second track end 216 (see FIG. 12), and the interface 166 of the selector 162 includes a keeper 218 shaped for removable engagement with the track 212. Here, the keeper 218 is disposed closer to the first track end 214 than to the second track end 216 when the selector 162 is disposed in the first selector position P1, and is disposed closer to the second track end 216 than to the first track end 214 when the selector 162 is disposed in the second selector position P2. In the illustrated version, the track 212 has a generally T-shaped profile and defines a first track region 220 adjacent to the first track end 214, a second track region 222 adjacent to the second track end 216, and a mount track region 224 arranged between the first and second track regions 220, 222 (see FIG. 12). The portions of the guide 152 and the selector 162 introduced above will each be described in greater detail below.

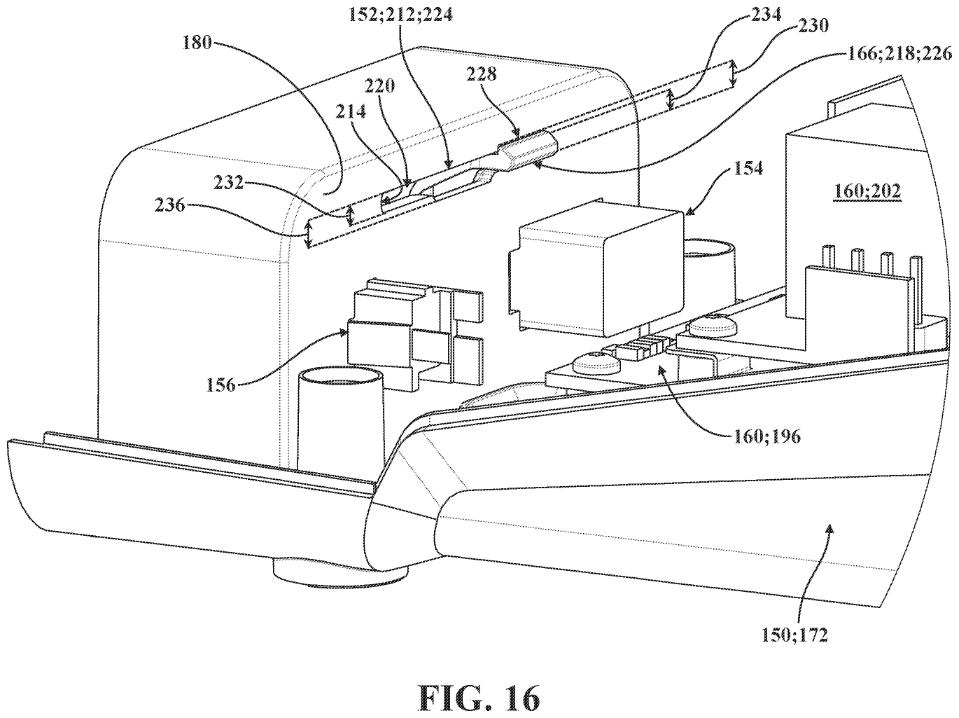

The first track region 220 is shaped and arranged to inhibit movement of the keeper 218 out of the track 212 when the selector 162 is disposed in the first selector position P1, and the second track region 222 is similarly shaped and arranged to inhibit movement of the keeper 218 out of the track 212 when the selector 162 is disposed in the second selector position P2. To this end, the keeper 218 of the interface 166 of the selector 162 includes a finger 226 extending to a catch 228. As depicted in FIG. 16, the catch 228 defines a catch height 230, and the first and second track regions 220, 222 define respective first and second track heights 232, 234 that are each smaller than the catch height 230. In the illustrated version, the first and second track heights 232, 234 are substantially equal to each other, but other configurations are contemplated.

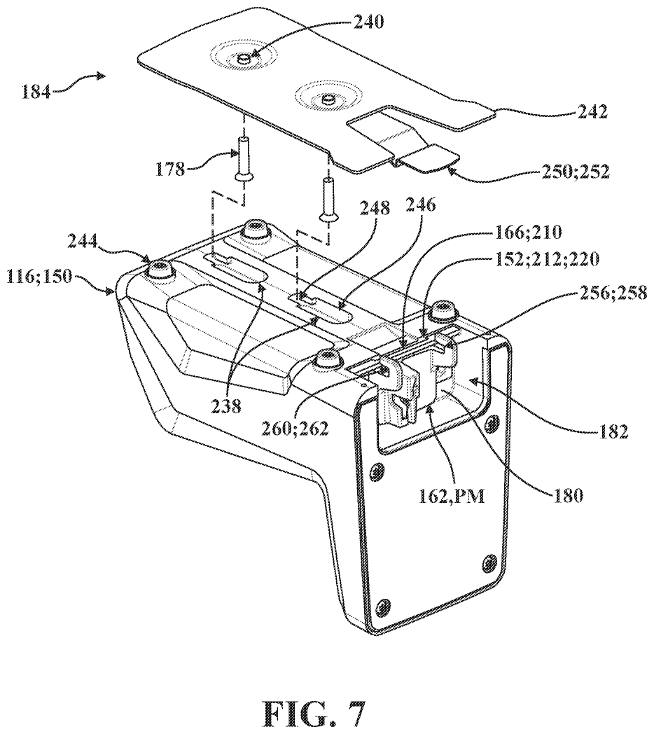

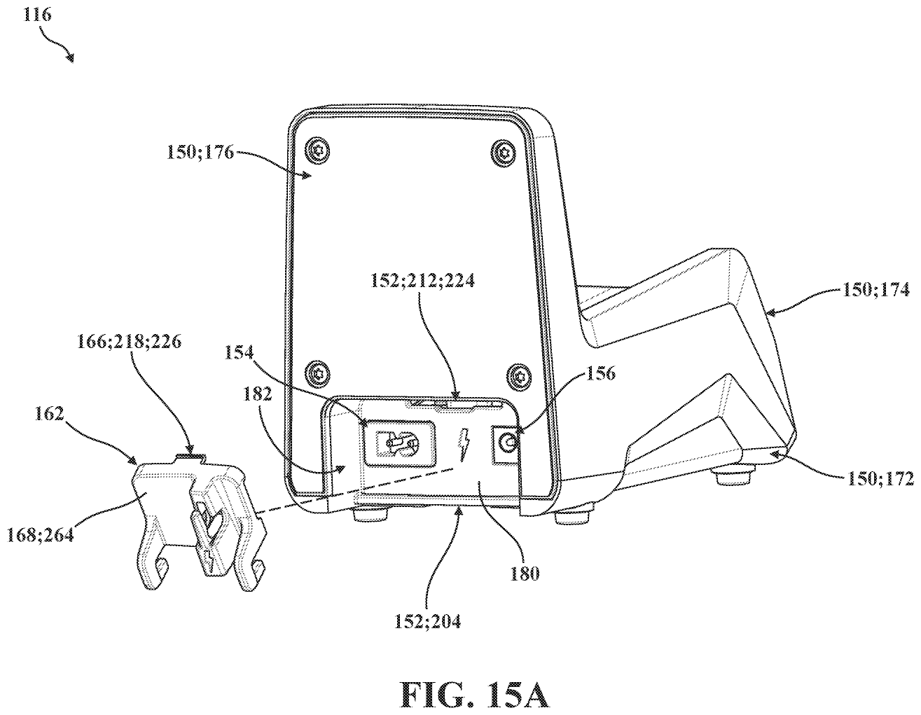

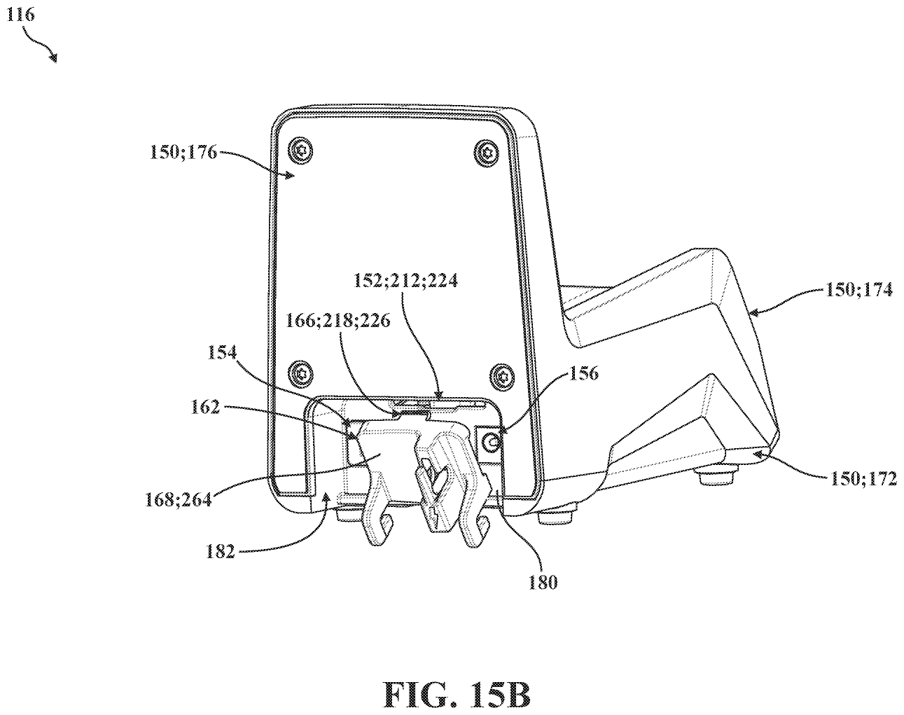

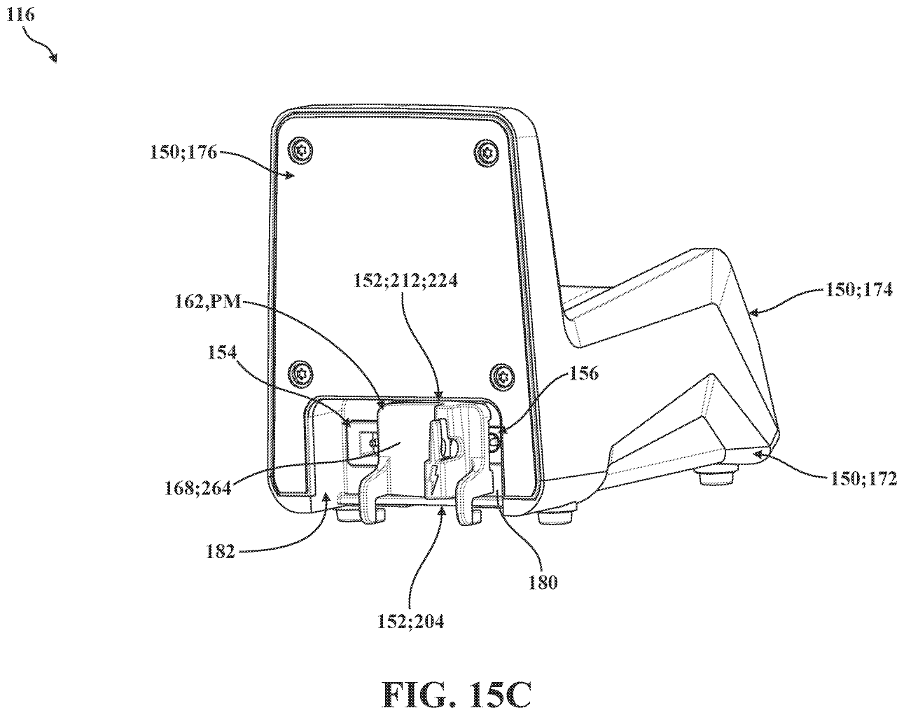

In addition to being arranged for movement between the first and second selector positions P1, P2, the selector 162 is also movable to a mount selector position PM arranged between the first selector position P1 and the second selector position P2 (see FIGS. 7 and 15C). Here, the mount track region 224 is shaped and arranged to permit movement of the keeper 218 of the interface 166 of the selector 162 out of the track 212 of the guide 152 when the selector 162 is disposed in the mount selector position PM. To this end, and as is depicted in FIG. 16, the mount track region 224 defines a mount track height 236 that is larger than the first track height 232 (as well as the second track height 234). With this configuration, the selector 162 can be removably secured or otherwise attached to the guide 152 in the manner depicted sequentially in FIGS. 15A-15C. Here, the tab 210 of the selector 162 can be inserted into the slot 204 of the guide 152, and the selector 162 can then be pivoted towards the housing 150 in order to move the finger 226 of the keeper 218 into the mount track region 224 of the track 212. The selector 162 can subsequently be moved into either the first or second selector positions P1, P2, which brings the catch 228 into secure engagement with a portion of the wall 180 located within the housing 150 (see FIG. 16).

Referring now to FIGS. 6-9, as noted above, the mounting assembly 184 is configured to facilitate releasable attachment of the housing 150 to environmental surfaces ES such as a portion of the room wall 112 or the cubby 120 depicted in FIG. 1. The environmental surface ES is depicted generically throughout drawings of the present disclosure, and may be realized by planar or non-planar walls, boards, and the like. As is best depicted in FIG. 7, one or more mount receivers 238 are operatively attached to the housing 150 are shaped and arranged to releasably engage one or more corresponding mount interfaces 240 of the mounting assembly 184 (see FIG. 6). The mount interfaces 240 are configured to receive fasteners 178 (e.g., screws, bolts, and the like) which, in turn, may be coupled to the environmental surface ES. The mounting assembly 184 also includes a bracket 242 operatively attached to the mount interfaces 240 which is arranged to abut against a portion of the environmental surface ES as well as against feet 244 operatively attached to the base body 172 of the housing 150. Here, the feet 244 may be manufactured from rubber or similar materials to minimize the transmission of vibrations between the charger 116 and the environmental surface ES. In scenarios where the mounting assembly 184 is not utilized, the feet 244 may be used to support the charger 116 on the environmental surface ES. Here too, in some scenarios where the mounting assembly 184 is not utilized, the plate 176 may be disposed in contact with the environmental surface ES, and may be provided with a rubberized or similar coating. Other configurations are contemplated.

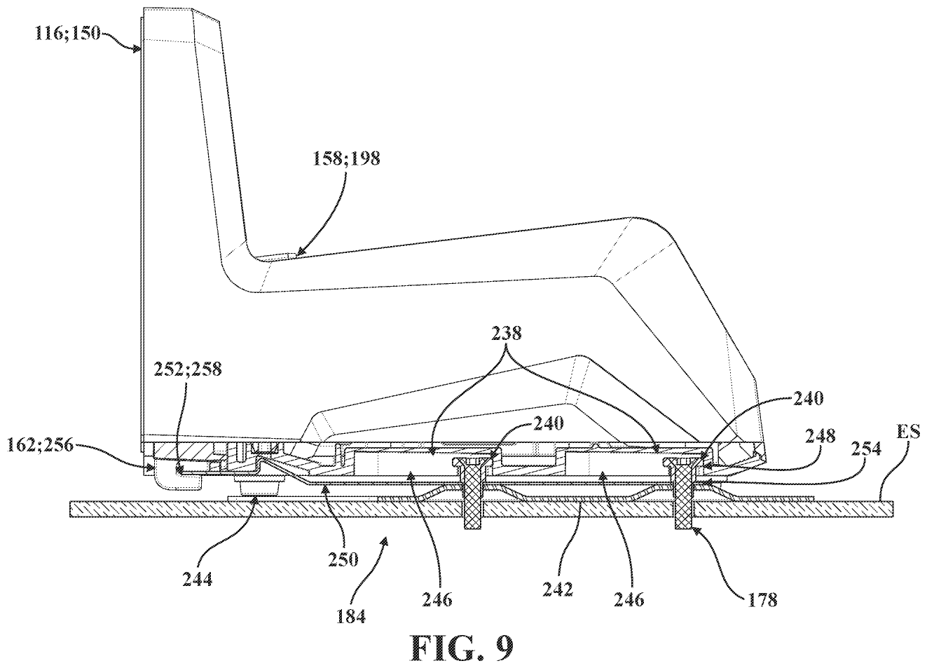

In the illustrated versions, the mount interfaces 240 have generally cylindrical, disc-shaped profiles, and the mount receivers 238 have elongated inlets 246 formed in the base body 172 that are shaped to receive the mount interfaces 240 (see FIG. 7). The mount receivers 238 also include recessed seats 248 disposed in communication with the elongated inlets 246 (see FIG. 7). Here, the mount interfaces 240 can be positioned into and translated along the elongated inlets 246 in order to come into engagement with the recessed seats 248 (see FIG. 9). This configuration limits relative movement between the bracket 242 and the housing 150 to sliding translational movement in a single direction (e.g., movement which would bring the mount interfaces 240 away from the recessed seats 248 along the elongated inlets 246).

Referring now to FIGS. 7-8B and 13-14, in the illustrated version, the mounting assembly 184 also includes or otherwise defines a brace 250 operatively attached to the bracket 242 (e.g., via the mount interfaces 240) and extending between a first brace end 252 and a second brace end 254. In order to restrict relative movement between the mounting assembly 184 and the housing 150, the selector 162 includes a first retainer 256 which extends away from the bastion 168 to a first stop 258, and a second retainer 260 disposed in spaced relation from the first retainer 256 which extends away from the bastion 168 to a second stops 262. While the illustrated version employs first and second retainers 256, 260 with respective first and second stops 258, 262, other configurations are contemplated, such as a single retainer defining one or more stops, more than two retainers, and the like.

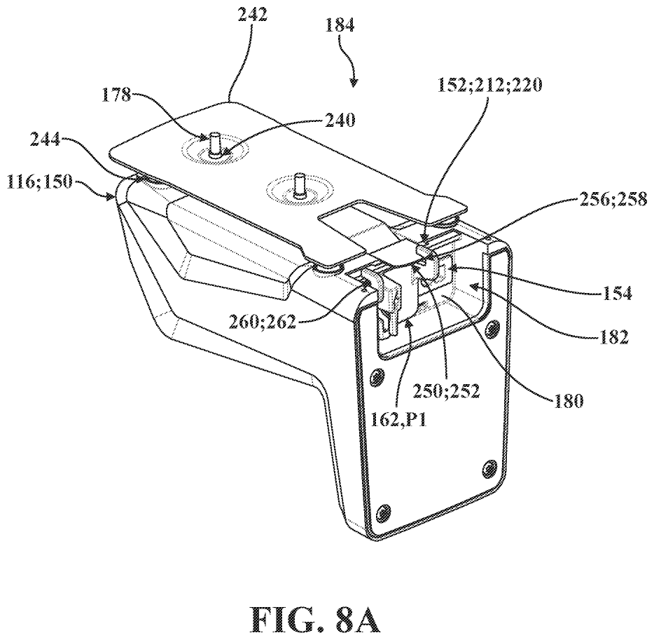

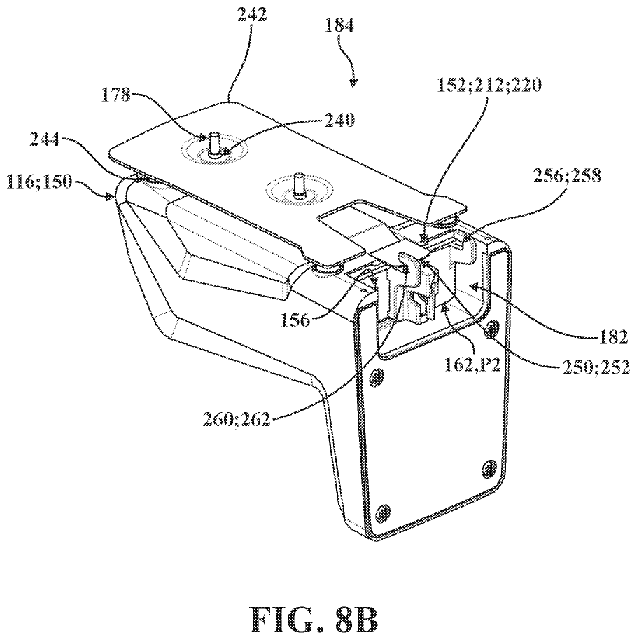

The first stop 258 is arranged to abut the first brace end 252 of the brace 250 when the selector 162 is disposed in the first selector position P1 to inhibit removal of the mount interfaces 240 from the mount receivers 238 (see FIG. 8A). The first stop 258 is also configured so as to be arranged in spaced relation from the brace 250 when the selector 162 is disposed in the mount selector position PM to facilitate removal of the mount interfaces 240 from the mount receivers 238. Similarly, the second stop 262 is arranged to abut the first brace end 252 of the brace 250 when the selector 162 is disposed in the second selector position P2 to inhibit removal of the mount interfaces 240 from the mount receivers 238 (see FIG. 8B). Here too, the second stop 262 is also configured so as to be arranged in spaced relation from the brace 250 when the selector 162 is disposed in the mount selector position PM to facilitate removal of the mount interfaces 240 from the mount receivers 238. While not depicted in detail herein, the brace 250 is disposed laterally between the first retainer 256 and the second retainer 260 when the selector is disposed in the mount selector position PM. It will be appreciated that connection of power cable connectors 194 to either of the first and second power connectors 154, 156 inhibits movement of the selector 162 between the first and second selector positions P1, P2. Thus, connection between one of the first and second power connectors 154, 156 with a power cable connector 194 also prevents the housing 150 from being released from the mounting assembly 184. Thus, the user has to disconnect the power cable connector 194 before the selector 162 can be moved to the mount selector position PM to either remove the selector 162 from the guide 152 or to facilitate removing the housing 150 from the mounting assembly 184.

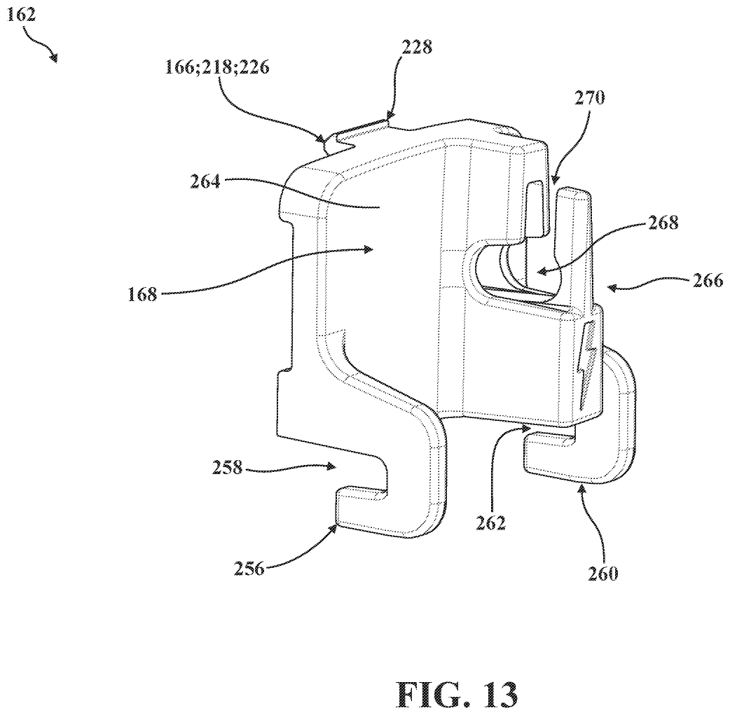

As noted above, the bastion 168 of the selector 162 is shaped and arranged to selectively inhibit access to one of the first and second power connectors 154, 156 while permitting access to the other of the first and second power connectors 154, 156. To this end, the bastion 168 of the illustrated version is at least partially defined by a selector wall 264 extending generally vertically between the tab 210 and the keeper 218, and extending generally laterally between the first and second retainers 256, 260. In some versions, the selector wall 264 may support or otherwise define a seal (not shown) arranged for engagement with one or more portions of the housing 150 (e.g., for abutment with the wall 180). In some versions, the selector 162 may also include a cable seat 266 extending from the selector wall 264 and arranged for retaining at least a portion of one of the power cables 192, such as is depicted in FIG. 3. In the illustrated version, and as is best depicted in FIG. 13, the cable seat 266 may define a cable pocket 268 and a cable inlet 270 in communication with the cable pocket 268 shaped to receive the power cable 192. Here, the cable pocket 268 accommodates and helps facilitate routing of the power cable 192. In the illustrated version, the cable seat 266 is spaced laterally between the keeper 218 and the second retainer 260. However, other configurations are contemplated. In some versions, this type of offset can be configured so as to compliment “angled” types of power cable connectors 194, such as is depicted in FIG. 3.

Referring now to FIGS. 11-12 and 18A-19B, as noted above, the retention mechanism 190 is operatively attached to the housing 150 and is configured releasably secure the battery 104 to the charger 116. To this end, the retention mechanism 190 generally includes one or more latches 272 arranged for movement relative to the housing 150 between respective retain positions PR where the latches 272 extend at least partially into the battery track 170 (see FIGS. 18A and 19A), and respective release positions PL (see FIGS. 18B and 19B) arranged to permit removal of the battery 104 from the battery track 170. Here, the latches 272 have latch catch faces 274 arranged to abut against respective battery stop faces 276 formed on the battery 104 (see FIG. 3; not shown in detail) in the retain position PR. In the illustrated version, two latches 272 are employed to retain the battery 104, but other configurations are contemplated (e.g., a single latch 272, more than two latches 272, other arrangements of latches 272, and the like). In order to facilitate movement of the latches 272 between the retain position PR and the release position PL, the retention mechanism 190 also includes a release element 278 operatively attached to the latches 272 and arranged for engagement by a user (e.g., a caregiver). Here, the release element 278 is realized as a “button” supported for movement relative to the cover 174 of the housing 150 that can be depressed by the user to move the latches 272 to the release position PL, at which point the battery 104 can be slid longitudinally along the battery track 170 until the battery slots 188 come out of sliding engagement with the charger rails 186. In the illustrated version, the retention mechanism 190 also includes a latch frame 280 that is operatively attached to the cover 174 via fasteners 178 and both retains and slidably supports the release element 278 and the latches 272 relative to the housing 150. In some versions, one or more biasing elements (not shown) may be provided so as to urge the latches 272 towards the retain position PR during an absence of user engagement with the release element 278.

In this way, the patient support system 100 of the present disclosure affords significant advantages relating to charging of removable batteries 104 utilized in the operation of various types of powered devices PD employed by patient transport apparatuses 102 by facilitating charging of batteries 104 with a single type and configuration of charger 116 that can be powered selectively from the first source type ST1 or the second source type ST2. More specifically, the bastion 168 of the selector 162 allows for reliably selective electrical communication with only one source of power at a time, which allows the charge circuit 160 to be configured with components that can be assembled or otherwise manufactured at significantly lower cost than would otherwise be required to accommodate potential simultaneous attachment to two different power source types ST1, ST2. Put differently, the selector 162 prevents the charger controller 196 and other components of the charge circuit 160 from becoming overloaded with power received simultaneously from different source types ST1, ST2. In addition, the patient support system 100 of the present disclosure affords opportunities for improved management of power cables 192 in that connection to the second source type ST2 can be achieved without external, bulky power converters wired in-line with the power cable 192 between the cable connector 194 and the second source type ST2. Furthermore, it will be appreciated that the patient support system 100 affords opportunities for secure mounting of chargers 116 in a number of different orientations while, at the same time, ensuring proper and consistent operation and battery 104 retention.

It will be further appreciated that the terms “include,” “includes,” and “including” have the same meaning as the terms “comprise,” “comprises,” and “comprising.” Moreover, it will be appreciated that terms such as “first,” “second,” “third,” and the like are used herein to differentiate certain structural features and components for the non-limiting, illustrative purposes of clarity and consistency.

Several configurations have been discussed in the foregoing description. However, the configurations discussed herein are not intended to be exhaustive or limit the invention to any particular form. The terminology which has been used is intended to be in the nature of words of description rather than of limitation. Many modifications and variations are possible in light of the above teachings and the invention may be practiced otherwise than as specifically described.

The present disclosure also comprises the following clauses, with specific features laid out in dependent clauses, that may specifically be implemented as described in greater detail with reference to the configurations and drawings above.

### CLAUSES

I. A charger for use in charging a battery of a patient transport apparatus via power selected from a first source type and second source type, the charger comprising:
a housing;
a guide operatively attached to the housing;
a first power connector operatively attached to the housing for receiving power from the first source type;
a second power connector operatively attached to the housing and disposed in spaced relation from the first power connector for receiving power from the second source type;
a charger connector for electrically coupling to the battery;
a charge circuit disposed in electrical communication with the charger connector, the first power connector, and the second power connector to charge the battery across the charger connector with power received from the first source type or from the second source type; and
a selector having an interface movably supported by the guide, and a bastion to prevent simultaneous electrical communication of the charge circuit with power from both the first source type and the second source type, the selector being selectively movable between:
   a first selector position where the bastion blocks access to the second power connector and permits access to the first power connector to facilitate electrical communication of the charge circuit with power from the first source type, and
   a second selector position where the bastion blocks access to the first power connector and permits access to the second power connector to facilitate electrical communication of the charge circuit with power from the second source type.

II. The charger as set forth in clause I, wherein the first power connector is configured to releasably receive an alternating current power cable connector when the selector is disposed in the first selector position.

III. The charger as set forth in any of clauses I-II, wherein the second power connector is configured to releasably receive a direct current power cable connector when the selector is disposed in the second selector position.

IV. The charger as set forth in any of clauses I-III, wherein the charge circuit includes a charger controller disposed in electrical communication with the charger connector, the first power connector, and the second power connector to regulate power transfer to the battery across the charger connector.

V. The charger as set forth in clause IV, wherein the charge circuit includes a power converter interposed in electrical communication between the first power connector and the charger controller to adjust one or more parameters of the power received from the first source type and to transfer adjusted power to the charger controller.

VI. The charger as set forth in clause V, wherein the power converter is configured to adjust a current of the power received from the first source type.

VII. The charger as set forth in any of clauses V-VI, wherein the power converter is configured to adjust a voltage of the power received from the first source type.

VIII. The charger as set forth in any of clauses V-VII, wherein the power converter is configured to adjust alternating current power received from the first source type into direct current power.

IX. The charger as set forth in any of clauses I-VIII, wherein the guide is formed integrally with the housing.

X. The charger as set forth in any of clauses I-IX, wherein the guide includes a slot extending between a first slot end and a second slot end; and
wherein the interface of the selector includes a tab shaped for removable engagement with the slot, with the tab abutting the first slot end when the selector is disposed in the first selector position, and with the tab abutting the second slot end when the selector is disposed in the second selector position.

XI. The charger as set forth in clause X, wherein engagement between the tab and the slot limits movement of the selector relative to the housing between the first selector position and the second selector position.

XII. The charger as set forth in any of clauses I-XI, wherein the guide includes a track disposed in spaced relation from the slot and extending between a first track end and a second track end; and
wherein the interface of the selector includes a keeper shaped for removable engagement with the track, with the keeper being disposed closer to the first track end than to the second track end when the selector is disposed in the first selector position.

XIII. The charger as set forth in clause XII, wherein the track defines:
a first track region disposed adjacent to the first track end and being shaped to inhibit movement of the keeper out of the track when the selector is disposed in the first selector position; and
a second track region disposed adjacent to the second track end and being shaped to inhibit movement of the keeper out of the track when the selector is disposed in the second selector position.

XIV. The charger as set forth in clause XIII, wherein the keeper of the interface of the selector includes a finger extending to a catch defining a catch height;
wherein the first track region defines a first track height smaller than the catch height; and
wherein the second track region defines a second track height smaller than the catch height.

XV. The charger as set forth in clause XIV, wherein the selector is movable to a mount selector position arranged between the first selector position and the second selector position; and
wherein the track defines a mount track region arranged between the first track region and the second track region and being shaped to permit movement of the keeper out of the track when the selector is disposed in the mount selector position.

XVI. The charger as set forth in clause XV, wherein the mount track region defines a mount track height larger than the first track height.

XVII. The charger as set forth in any of clauses XV-XVI, further including a mounting assembly having a mount interface for releasably engaging the housing, and a bracket operatively attached to the mount interface for securing to an environmental surface.

XVIII. The charger as set forth in clause XVII, further including a mount receiver operatively attached to the housing and shaped to releasably engage the mount interface of the mounting assembly.

XIX. The charger as set forth in clause XVIII, wherein the mounting assembly defines a brace operatively attached to the bracket and extending between a first brace end and a second brace end; and
wherein the selector includes a first retainer extending away from the bastion to a first stop arranged:
   to abut the first brace end when the selector is disposed in the first selector position to inhibit removal of the mount interface from the mount receiver, and
   disposed in spaced relation from the brace when the selector is disposed in the mount selector position to facilitate removal of the mount interface from the mount receiver.

XX. The charger as set forth in clause XIX, wherein the selector includes a second retainer extending away from the bastion to a second stop arranged:
to abut the first brace end when the selector is disposed in the second selector position to inhibit removal of the mount interface from the mount receiver, and
disposed in spaced relation from the brace when the selector is disposed in the mount selector position to facilitate removal of the mount interface from the mount receiver.

XXI. The charger as set forth in clause XX, wherein the brace is disposed laterally between the first retainer and the second retainer when the selector is disposed in the mount selector position.

XXII. The charger as set forth in any of clauses I-XXI, wherein the selector is removably attachable to the guide.

XXIII. The charger as set forth in any of clauses I-XXII, wherein the selector includes a cable seat for removably retaining at least a portion of a power cable.

XXIV. The charger as set forth in any of clauses I-XXIII, wherein the housing defines a battery track for slidably receiving the battery.

XXV. The charger as set forth in clause XXIV, further including a retention mechanism operatively attached to the housing for releasably securing the battery to the housing.

XXVI. The charger as set forth in clause XXV, wherein the retention mechanism includes a latch arranged for movement relative to the housing between:
a retain position extending into the battery track for engaging the battery; and
a release position arranged to permit removing the battery from the battery track.

XXVII. The charger as set forth in clause XXVI, wherein the retention mechanism includes a release element operatively attached to the latch and arranged for engagement by a user to move the latch from the retain position to the release position.

XXVIII. A patient support system comprising:
a patient transport apparatus including:
   a base arranged for movement about floor surfaces,
   an intermediate frame with a patient support deck for supporting a patient,
   a lift mechanism having an actuator to move the intermediate frame relative to the base,
   an apparatus connector, and
   an apparatus controller disposed in electrical communication with the actuator and the apparatus connector;
a battery having a battery connector; and
a charger as set forth in any of claims I-XXVII.

XXIX. A patient support system comprising:
a patient transport apparatus including:
   a base arranged for movement about floor surfaces,
   an intermediate frame with a patient support deck for supporting a patient,
   a lift mechanism having an actuator to move the intermediate frame relative to the base,
   an apparatus connector, and
   an apparatus controller disposed in electrical communication with the actuator and the apparatus connector;
a battery having a battery connector; and
a charger to charge the battery via power selected from a first source type and second source type, the charger including:
   a housing;
   a guide operatively attached to the housing,
   a first power connector operatively attached to the housing for receiving power from the first source type,
   a second power connector operatively attached to the housing and disposed in spaced relation from the first power connector for receiving power from the second source type,
   a charger connector for electrically coupling to the battery connector of the battery,
   a charge circuit disposed in electrical communication with the charger connector, the first power connector, and the second power connector to charge the battery across the charger connector coupled to the battery connector with power received from the first source type or from the second source type, and
   a selector having an interface movably supported by the guide, and a bastion to prevent simultaneous electrical communication of the charge circuit with power from both the first source type and the second source type, the selector being selectively movable between:
      a first selector position where the bastion blocks access to the second power connector and permits access to the first power connector to facilitate electrical communication of the charge circuit with power from the first source type, and
      a second selector position where the bastion blocks access to the first power connector and permits access to the second power connector to facilitate electrical communication of the charge circuit with power from the second source type.

XXX. The patient support system as set forth in clause XXIX, wherein the first power connector is configured to releasably receive an alternating current power cable connector when the selector is disposed in the first selector position.

XXXI. The patient support system as set forth in any of clauses XXIX-XXX, wherein the second power connector is configured to releasably receive a direct current power cable connector when the selector is disposed in the second selector position.

XXXII. The patient support system as set forth in any of clauses XXIX-XXXI, wherein the charge circuit includes a charger controller disposed in electrical communication with the charger connector, the first power connector, and the second power connector to regulate power transfer to the battery across the charger connector.

XXXIII. The patient support system as set forth in clause XXXII, wherein the charge circuit includes a power converter interposed in electrical communication between the first power connector and the charger controller to adjust one or more parameters of the power received from the first source type and to transfer adjusted power to the charger controller.

XXXIV. The patient support system as set forth in clause XXXIII, wherein the power converter is configured to adjust a current of the power received from the first source type.

XXXV. The patient support system as set forth in any of clauses XXXIII-XXXIV, wherein the power converter is configured to adjust a voltage of the power received from the first source type.

XXXVI. The patient support system as set forth in any of clauses XXXIII-XXXV, wherein the power converter is configured to adjust alternating current power received from the first source type into direct current power.

XXXVII. The patient support system as set forth in any of clauses XXIX-XXXVI, wherein the guide is formed integrally with the housing.

XXXVIII. The patient support system as set forth in any of clauses XXIX-XXXVII, wherein the guide includes a slot extending between a first slot end and a second slot end; and
wherein the interface of the selector includes a tab shaped for removable engagement with the slot, with the tab abutting the first slot end when the selector is disposed in the first selector position, and with the tab abutting the second slot end when the selector is disposed in the second selector position.

XXXIX. The patient support system as set forth in clause XXXVIII, wherein engagement between the tab and the slot limits movement of the selector relative to the housing between the first selector position and the second selector position.

XL. The patient support system as set forth in any of clauses XXIX-XXXIX, wherein the guide includes a track disposed in spaced relation from the slot and extending between a first track end and a second track end; and
wherein the interface of the selector includes a keeper shaped for removable engagement with the track, with the keeper being disposed closer to the first track end than to the second track end when the selector is disposed in the first selector position.

XLI. The patient support system as set forth in clause XL, wherein the track defines:
a first track region disposed adjacent to the first track end and being shaped to inhibit movement of the keeper out of the track when the selector is disposed in the first selector position; and
a second track region disposed adjacent to the second track end and being shaped to inhibit movement of the keeper out of the track when the selector is disposed in the second selector position.

XLII. The patient support system as set forth in clause XLI, wherein the keeper of the interface of the selector includes a finger extending to a catch defining a catch height;
wherein the first track region defines a first track height smaller than the catch height; and
wherein the second track region defines a second track height smaller than the catch height.

XLIII. The patient support system as set forth in clause XLII, wherein the selector is movable to a mount selector position arranged between the first selector position and the second selector position; and
wherein the track defines a mount track region arranged between the first track region and the second track region and being shaped to permit movement of the keeper out of the track when the selector is disposed in the mount selector position.

XLIV. The patient support system as set forth in clause XLIII, wherein the mount track region defines a mount track height larger than the first track height.

XLV. The patient support system as set forth in any of clauses XLIII-XLIV, further including a mounting assembly having a mount interface for releasably engaging the housing, and a bracket operatively attached to the mount interface for securing to an environmental surface.

XLVI. The patient support system as set forth in clause XLV, further including a mount receiver operatively attached to the housing and shaped to releasably engage the mount interface of the mounting assembly.

XLVII. The patient support system as set forth in clause XLVI, wherein the mounting assembly defines a brace operatively attached to the bracket and extending between a first brace end and a second brace end; and
wherein the selector includes a first retainer extending away from the bastion to a first stop arranged:
   to abut the first brace end when the selector is disposed in the first selector position to inhibit removal of the mount interface from the mount receiver, and
   disposed in spaced relation from the brace when the selector is disposed in the mount selector position to facilitate removal of the mount interface from the mount receiver.

XLVIII. The patient support system as set forth in clause XLVII, wherein the selector includes a second retainer extending away from the bastion to a second stop arranged:
to abut the first brace end when the selector is disposed in the second selector position to inhibit removal of the mount interface from the mount receiver, and
disposed in spaced relation from the brace when the selector is disposed in the mount selector position to facilitate removal of the mount interface from the mount receiver.

XLIX. The patient support system as set forth in clause XL VIII, wherein the brace is disposed laterally between the first retainer and the second retainer when the selector is disposed in the mount selector position.

L. The patient support system as set forth in any of clauses XXIX-XLIX, wherein the selector is removably attachable to the guide.

LI. The patient support system as set forth in any of clauses XXIX-L, wherein the selector includes a cable seat for removably retaining at least a portion of a power cable.

LII. The patient support system as set forth in any of clauses XXIX-LI, wherein the housing defines a battery track for slidably receiving the battery.

LIII. The patient support system as set forth in clause LII, further including a retention mechanism operatively attached to the housing for releasably securing the battery to the housing.

LIV. The patient support system as set forth in clause LIII, wherein the retention mechanism includes a latch arranged for movement relative to the housing between:
a retain position extending into the battery track for engaging the battery; and
a release position arranged to permit removing the battery from the battery track.

LV. The patient support system as set forth in clause LIV, wherein the retention mechanism includes a release element operatively attached to the latch and arranged for engagement by a user to move the latch from the retain position to the release position.

1. A charger for use in charging a battery of a patient transport apparatus via power selected from a first source type and second source type, the charger comprising:
a housing;
a guide operatively attached to the housing;
a first power connector operatively attached to the housing for receiving power from the first source type;
a second power connector operatively attached to the housing and disposed in spaced relation from the first power connector for receiving power from the second source type;
a charger connector for electrically coupling to the battery;
a charge circuit disposed in electrical communication with the charger connector, the first power connector, and the second power connector to charge the battery across the charger connector with power received from the first source type or from the second source type; and a selector having an interface movably supported by the guide, and a bastion to prevent simultaneous electrical communication of the charge circuit with power from both the first source type and the second source type, the selector being selectively movable between:
a first selector position where the bastion blocks access to the second power connector and permits access to the first power connector to facilitate electrical communication of the charge circuit with power from the first source type, and
a second selector position where the bastion blocks access to the first power connector and permits access to the second power connector to facilitate electrical communication of the charge circuit with power from the second source type.

2. The charger as set forth in claim 1, wherein the first power connector is configured to releasably receive an alternating current power cable connector when the selector is disposed in the first selector position.

3. The charger as set forth in claim 1, wherein the second power connector is configured to releasably receive a direct current power cable connector when the selector is disposed in the second selector position.

4. The charger as set forth in claim 1, wherein the charge circuit includes a charger controller disposed in electrical communication with the charger connector, the first power connector, and the second power connector to regulate power transfer to the battery across the charger connector.

5. The charger as set forth in claim 4, wherein the charge circuit includes a power converter interposed in electrical communication between the first power connector and the charger controller to adjust one or more parameters of the power received from the first source type and to transfer adjusted power to the charger controller.

6. The charger as set forth in claim 5, wherein the power converter is configured to adjust a current of the power received from the first source type.

7. The charger as set forth in claim 5, wherein the power converter is configured to adjust a voltage of the power received from the first source type.

8. The charger as set forth in claim 5, wherein the power converter is configured to adjust alternating current power received from the first source type into direct current power.

9. The charger as set forth in claim 1, wherein the guide is formed integrally with the housing.

10. The charger as set forth in claim 1, wherein the guide includes a slot extending between a first slot end and a second slot end; and
wherein the interface of the selector includes a tab shaped for removable engagement with the slot, with the tab abutting the first slot end when the selector is disposed in the first selector position, and with the tab abutting the second slot end when the selector is disposed in the second selector position.

11. The charger as set forth in claim 10, wherein engagement between the tab and the slot limits movement of the selector relative to the housing between the first selector position and the second selector position.

12. The charger as set forth in claim 10, wherein the guide includes a track disposed in spaced relation from the slot and extending between a first track end and a second track end; and
wherein the interface of the selector includes a keeper shaped for removable engagement with the track, with the keeper being disposed closer to the first track end than to the second track end when the selector is disposed in the first selector position.

13. The charger as set forth in claim 12, wherein the track defines:
a first track region disposed adjacent to the first track end and being shaped to inhibit movement of the keeper out of the track when the selector is disposed in the first selector position; and
a second track region disposed adjacent to the second track end and being shaped to inhibit movement of the keeper out of the track when the selector is disposed in the second selector position.

14. The charger as set forth in claim 13, wherein the keeper of the interface of the selector includes a finger extending to a catch defining a catch height;
wherein the first track region defines a first track height smaller than the catch height; and wherein the second track region defines a second track height smaller than the catch height.

15. The charger as set forth in claim 14, wherein the selector is movable to a mount selector position arranged between the first selector position and the second selector position; and
wherein the track defines a mount track region arranged between the first track region and the second track region and being shaped to permit movement of the keeper out of the track when the selector is disposed in the mount selector position.

16. (canceled)

17. The charger as set forth in claim 15, further including a mounting assembly having a mount interface for releasably engaging the housing, and a bracket operatively attached to the mount interface for securing to an environmental surface.

18. The charger as set forth in claim 17, further including a mount receiver operatively attached to the housing and shaped to releasably engage the mount interface of the mounting assembly.

19. The charger as set forth in claim 18, wherein the mounting assembly defines a brace operatively attached to the bracket and extending between a first brace end and a second brace end; and
wherein the selector includes a first retainer extending away from the bastion to a first stop arranged:
to abut the first brace end when the selector is disposed in the first selector position to inhibit removal of the mount interface from the mount receiver, and
disposed in spaced relation from the brace when the selector is disposed in the mount selector position to facilitate removal of the mount interface from the mount receiver; and
wherein the selector includes a second retainer extending away from the bastion to a second stop arranged:
to abut the first brace end when the selector is disposed in the second selector position to inhibit removal of the mount interface from the mount receiver, and
disposed in spaced relation from the brace when the selector is disposed in the mount selector position to facilitate removal of the mount interface from the mount receiver.

20. (canceled)

21. (canceled)

22. (canceled)

23. The charger as set forth in claim 1, wherein the selector includes a cable seat for removably retaining at least a portion of a power cable.

24. The charger as set forth in claim 1, wherein the housing defines a battery track for slidably receiving the battery.

25. (canceled)

26. (canceled)

27. (canceled)

28. (canceled)
